(19) United States
(12) Patent Application Publication
(10) Pub. No.: US 2016/0257344 A1
(43) Pub. Date: Sep. 8, 2016

(54) VEHICLE FRAMEWORK STRUCTURE

(71) Applicant: TOYOTA JIDOSHA KABUSHIKI KAISHA, Toyota-shi (JP)

(72) Inventors: Yasutaka HASEGAWA, Toyota-shi (JP); Kaoru MIYAMOTO, Toyota-shi (JP)

(73) Assignee: TOYOTA JIDOSHA KABUSHIKI KAISHA, Toyota-shi (JP)

(21) Appl. No.: 15/040,403

(22) Filed: Feb. 10, 2016

(30) Foreign Application Priority Data
Mar. 3, 2015 (JP) 2015-041754

(51) Int. Cl. B62D 21/15; B62D 25/04

(52) U.S. Cl. CPC B62D 21/152; B62D 25/04

(57) ABSTRACT

A vehicle framework structure according to a first aspect includes: a framework member that structures a framework of a vehicle, a cross-sectional shape of the framework member viewed in a length direction thereof being formed as a closed cross section shape; a reinforcing rod disposed inside the framework member along the length direction of the framework member; and a plurality of brackets provided inside the framework member so as to be spaced apart in a length direction of the reinforcing rod, the plurality of brackets supporting the reinforcing rod.

### CROSS-REFERENCE TO RELATED APPLICATION

This application is based on and claims priority under 35 USC 119 from Japanese Patent Application No. 2015-041754 filed on Mar. 3, 2015, the disclosure of which is incorporated by reference herein.

### TECHNICAL FIELD

The present invention relates to a vehicle framework structure.

### RELATED ART

There is a center pillar (for example, see Japanese Patent Application Laid-Open (JP-A) No. H11-99960) that structures a framework of a vehicle side portion and whose interior is filled with a foam material.

However, if a framework member structuring a framework of a vehicle deforms in association with a vehicle collision, an amount of deformation of a vehicle cabin may be large.

### SUMMARY

Accordingly, an object of the present invention is to provide a vehicle framework structure that may suppress deformation of a framework member in association with a vehicle collision.

A vehicle framework structure according to a first aspect includes: a framework member that structures a framework of a vehicle, a cross-sectional shape of the framework member viewed in a length direction thereof being formed as a closed cross section shape; a reinforcing rod disposed inside the framework member along the length direction of the framework member; and a plurality of brackets provided inside the framework member so as to be spaced apart in a length direction of the reinforcing rod, the plurality of brackets supporting the reinforcing rod.

According to the structure described above, the cross-sectional shape of the framework member structuring the framework of the vehicle, as viewed in the length direction thereof, is formed as the closed cross section shape. The reinforcing rod is disposed inside the framework member, along the length direction of the framework member. The plural brackets are also provided inside the framework member. The brackets are provided to be spaced apart in the length direction of the reinforcing rod and support the reinforcing rod with respect to the framework member. Thus, the framework member is reinforced by the reinforcing rod. Therefore, deformation of the framework member in association with a vehicle collision is suppressed.

In a vehicle framework structure according to a second aspect, in the vehicle framework structure according to the first aspect, the reinforcing rod includes a tubular hollow portion.

According to the structure described above, the reinforcing rod includes the tubular hollow portion. Thus, for example, if a load inputted to the reinforcing rod is at least a predetermined value, the hollow portion is crushed, absorbing collision energy. Therefore, deformation of the framework member in association with a vehicle collision is further suppressed.

In a vehicle framework structure according to a third aspect, the vehicle framework structure according to the first aspect or the second aspect further comprising a foam material filled into the inside of the framework member, wherein at least a portion of the reinforcing rod is embedded in the foam material.

According to the structure described above, the foam material is filled into the inside of the framework member and at least a portion of the reinforcing rod is embedded in the foam material. Therefore, a collision load is transmitted between the framework member and the reinforcing rod via the foam material. Moreover, because the cross-sectional shape of the framework member is maintained by the foam material, crushing of the framework member (buckling of the cross section) in association with a vehicle collision is suppressed. Therefore, deformation of the framework member in association with a vehicle collision is further suppressed.

In a vehicle framework structure according to a fourth aspect, in the vehicle framework structure according to any one of the first to third aspects, wherein at least one of the plurality of brackets is a bulkhead that includes a partition wall portion that is disposed with a thickness direction thereof in the length direction of the framework member, and that is fitted into the inside of the framework member, and the reinforcing rod penetrates the partition wall portion.

According to the structure described above, at least one of the plural brackets serves as a bulkhead. This bulkhead includes a partition wall portion. The partition wall portion is disposed with the thickness direction thereof along the length direction of the framework member. Moreover, the partition wall portion is tightly fitted into the inside of the framework member, and the reinforcing rod penetrates the partition wall portion. A load is transmitted between the framework member and the reinforcing rod via the partition wall portion. Moreover, because the cross-sectional shape of the framework member is maintained by the partition wall portion, crushing of the framework member (buckling of the cross section) in association with a vehicle collision is suppressed. Therefore, deformation of the framework member in association with a vehicle collision is further suppressed.

In a vehicle framework structure according to a fifth aspect, in the vehicle framework structure according to any one of the first to fourth aspects, wherein: the framework member includes: a front pillar disposed at a side portion of a front end side of a vehicle cabin; and a roof side rail that extends toward a vehicle rear side from an upper end portion of the front pillar; the reinforcing rod is provided to extend along the front pillar and the roof side rail; and the brackets are provided in each of the front pillar and the roof side rail.

When, in association with a vehicle frontal collision (hereinafter referred to simply as a “front impact”), a front impact load toward a vehicle rear side is inputted to the front pillar, stress may concentrate at a joint portion between the front pillar and the roof side rail, and a deformation in which the joint portion bends into a protrusion toward the vehicle upper side may occur.

However, in the present aspect, the reinforcing rod is provided extending along both the front pillar and the roof side rail. The reinforcing rod is supported by the brackets that are provided in each of the front pillar and the roof side rail.

Therefore, a front impact load that is inputted to the front pillar in association with a front impact is transmitted to the roof side rail via the reinforcing rod. As a result, stress concentrating at the joint portion between the front pillar and the roof side rail is reduced. Therefore, a deformation in which the joint portion between the front pillar and the roof side rail bends toward the vehicle upper side is suppressed.

In a vehicle framework structure according to a sixth aspect, in the vehicle framework structure according to the fifth aspect, wherein: the front pillar includes: a front pillar lower that is disposed along a vehicle vertical direction; and a front pillar upper that extends toward a vehicle upper side and the vehicle rear side from an upper end portion of the front pillar lower, an upper end portion of the front pillar upper being joined to a front end portion of the roof side rail; a front end portion of the reinforcing rod is supported by a bracket of the plurality of brackets that is provided inside the front pillar upper; and a rear end portion of the reinforcing rod is supported by a bracket of the plurality of brackets that is provided inside the roof side rail.

According to the structure described above, the front pillar includes the front pillar lower and the front pillar upper. The front pillar lower is disposed along the vehicle vertical direction. The front pillar upper extends toward the vehicle upper side and the vehicle rear side from the upper end portion of the front pillar lower, and the upper end portion of the front pillar upper is joined to the front end portion of the roof side rail. The front end portion of the reinforcing rod is supported at the bracket that is provided inside the front pillar upper, and the rear end portion of the reinforcing rod is supported at the bracket that is provided inside the roof side rail.

Because the reinforcing rod is provided extending along both the front pillar upper and the roof side rail, and the front end portion of the reinforcing rod and the rear end portion of the reinforcing rod are supported by the brackets provided inside the front pillar upper and the roof side rail, the joint portion between the front pillar and the roof side rail may be effectively reinforced.

In a vehicle framework structure according to a seventh aspect, the vehicle framework structure according to the fifth aspect further comprising an apron upper member that extends toward a vehicle front side from the front pillar, wherein a front end portion of the reinforcing rod is disposed at the vehicle rear side relative to the apron upper member.

According to the structure described above, the apron upper member that extends toward the vehicle front side from the front pillar is provided. The front end portion of the reinforcing rod is disposed at the vehicle rear side relative to the apron upper member.

If a collision body collides with a front face of a vehicle at the outer side in a vehicle width direction relative to a front side member (hereinafter, this collision mode is referred to as a “micro-wrap collision”), the collision body may pass along at the vehicle width direction outer side of the front side member and collide with a front pillar directly or via a front wheel. If, for example, a vehicle has a micro-wrap collision with a vehicle such as a sport utility vehicle (SUV) or the like in which the location of a front bumper is higher than in an ordinary vehicle (for example, a sedan), the collision body may collide with a joint portion between the front pillar and an apron upper member or a portion peripheral to this joint portion.

However, in the present aspect, as mentioned above, the front end portion of the reinforcing rod is disposed at the vehicle rear side relative to the apron upper member. Therefore, a collision load that is inputted to a joint portion between the front pillar and the apron upper member or to a portion peripheral to the joint portion may be borne by the front end portion of the reinforcing rod. Therefore, deformation (tilting) of the front pillar toward the vehicle rear side in association with a micro-wrap collision with an SUV or the like is suppressed.

As described above, according to the vehicle framework structure of the present invention, deformation of a framework member in association with a vehicle collision may be suppressed.

### BRIEF DESCRIPTION OF THE DRAWINGS

Exemplary embodiments of the present invention will be described in detail based on the following figures, wherein:

FIG. 1 is a side view, viewed from a vehicle width direction outer side, of a front pillar and a roof side rail in which a vehicle framework structure in accordance with a first exemplary embodiment is employed;

FIG. 2 is a magnified sectional diagram cut along line F2-F2 in FIG. 1;

FIG. 3 is a magnified sectional diagram cut along line F3-F3 in FIG. 1;

FIG. 4 is a side view, corresponding to FIG. 1, showing a front pillar and a roof side rail in which a variant example of the vehicle framework structure in accordance with the first exemplary embodiment is employed;

FIG. 5 is a side view, viewed from the vehicle width direction outer side, of a rocker and a front pillar in which a vehicle framework structure in accordance with a second exemplary embodiment is employed;

FIG. 6 is a magnified sectional diagram cut along line F6-F6 in FIG. 5;

FIG. 7 is a magnified sectional diagram cut along line F7-F7 in FIG. 5;

FIG. 8 is a magnified sectional diagram cut along line F8-F8 in FIG. 5;

FIG. 9 is a magnified side view, corresponding to FIG. 5, showing a rocker and a front pillar in which a variant example of the vehicle framework structure in accordance with the second exemplary embodiment is employed;

FIG. 10 is a magnified side view, corresponding to FIG. 5, showing a rocker and a front pillar in which a variant example of the vehicle framework structure in accordance with the second exemplary embodiment is employed;

FIG. 11 is a magnified side view, corresponding to FIG. 5, showing a rocker and a front pillar in which a variant example of the vehicle framework structure in accordance with the second exemplary embodiment is employed;

FIG. 12 is a magnified side view, corresponding to FIG. 5, showing a rocker and a front pillar in which a variant example of the vehicle framework structure in accordance with the second exemplary embodiment is employed;

FIG. 13 is a side view, corresponding to FIG. 5, showing a rocker, a front pillar and a roof side rail in which a variant example of the vehicle framework structure in accordance with the second exemplary embodiment is employed;

FIG. 14 is a magnified side view, corresponding to FIG. 5, showing a rocker and a front pillar in which a variant example of the vehicle framework structure in accordance with the second exemplary embodiment is employed;

FIG. 15 is a side view, viewed from the vehicle width direction outer side, of a rocker and a center pillar in which a vehicle framework structure in accordance with a third exemplary embodiment is employed;

FIG. 16 is a magnified sectional diagram cut along line F16-F16 in FIG. 15;

FIG. 17 is a magnified side view, corresponding to FIG. 15, showing a rocker and a center pillar in which a variant example of the vehicle framework structure in accordance with the third exemplary embodiment is employed; and

FIG. 18 is a side view, corresponding to FIG. 15, showing a center pillar in which a variant example of the vehicle framework structure in accordance with the third exemplary embodiment is employed.

### DETAILED DESCRIPTION

Here below, a vehicle framework structure is described in relation to exemplary embodiments of the present invention. The arrow FR that is shown where appropriate in the drawings indicates a vehicle front side (the front side in a vehicle front-rear direction), the arrow UP indicates a vehicle upper side (the upper side in a vehicle vertical direction), and the arrow IN indicates a vehicle width direction inner side.

First, a first exemplary embodiment is described.

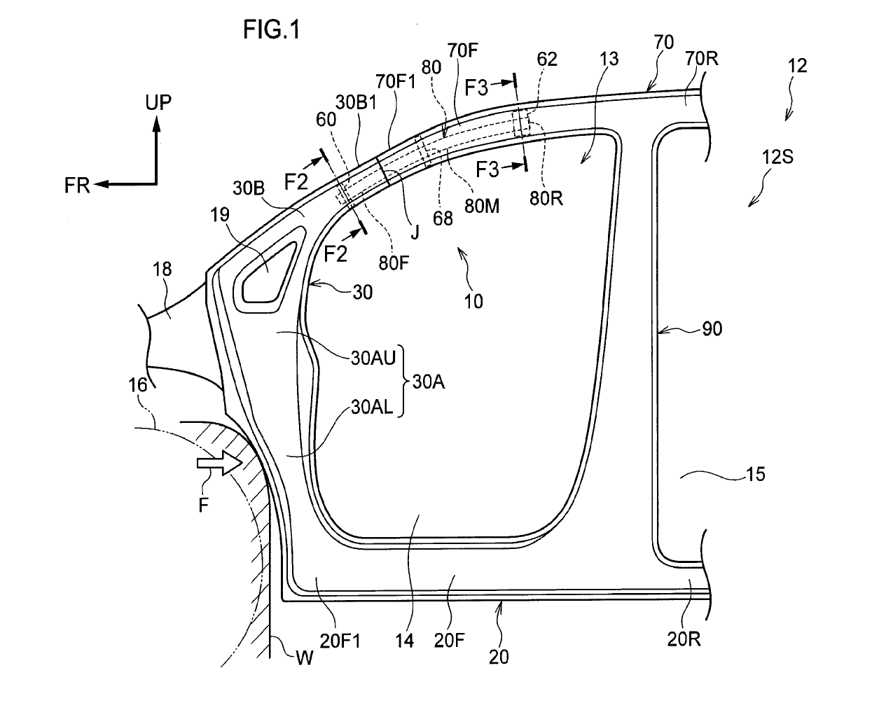

As shown in FIG. 1, a vehicle framework structure 10 in accordance with the first exemplary embodiment is employed at a front pillar 30 and a roof side rail 70 that structure a framework of a vehicle side portion 12S of a vehicle 12. In the vehicle side portion 12S, a front door opening portion 14 and a rear door opening portion 15, for vehicle occupants to board and alight through, are formed side-by-side in the vehicle front-rear direction. The vehicle side portion 12S is provided with a rocker 20, the front pillar 30, the roof side rail 70 and a center pillar 90, which structure the framework of the vehicle side portion 12S.

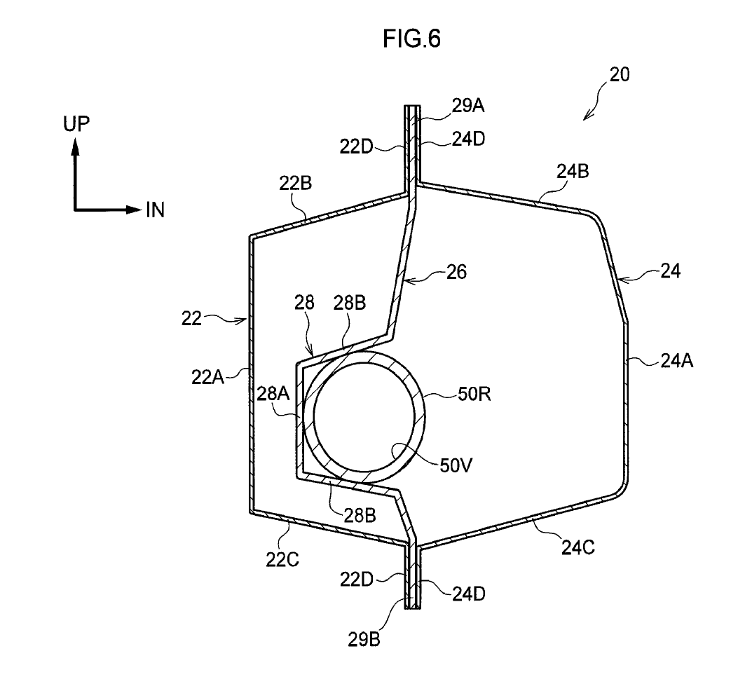

The rocker 20 is a framework member in a beam shape that is fabricated of metal. The rocker 20 forms lower edge portions at the vehicle lower sides of the front door opening portion 14 and the rear door opening portion 15. The rocker 20 is disposed along the vehicle front-rear direction at the lower portion of the vehicle side portion 12S. More specifically, the rocker 20 is disposed along the vehicle front-rear direction at each of two vehicle width direction sides of a vehicle body floor (a floor panel), which is not shown in the drawings. A cross-sectional shape of the rocker 20, viewed in the vehicle front-rear direction, is formed as a closed cross section shape (see FIG. 6). The rocker 20 includes a front portion 20F at the vehicle front side relative to the center pillar 90 and a rear portion 20R at the vehicle rear side relative to the center pillar 90.

The front pillar 30 is a framework member formed as a column shape that is fabricated of metal. The front pillar 30 forms a front edge portion at the vehicle front side of the front door opening portion 14. The front pillar 30 is disposed at a side portion at the front end side of a vehicle cabin 13. The front pillar 30 includes a front pillar lower 30A and a front pillar upper 30B.

The front pillar lower 30A is disposed at each of two sides in the vehicle width direction of a dash panel, which is not shown in the drawings. The front pillar lower 30A rises up in the vehicle vertical direction from a front end portion 20F1 at the vehicle front side of the rocker 20. A front side door, which is not shown in the drawings, opens and closes the front door opening portion 14. The front side door is swingably mounted at the front pillar lower 30A via a door hinge. The front pillar upper 30B is joined to an upper end portion of the front pillar lower 30A.

A front wheel 16 is disposed at the vehicle front side relative to a lower portion 30AL of the front pillar lower 30A. An apron upper member 18 extends toward the vehicle front side from an upper portion 30AU of the front pillar lower 30A. A non-opening window 19, with a triangular shape as viewed in the vehicle width direction, is provided at the upper portion 30AU of the front pillar lower 30A.

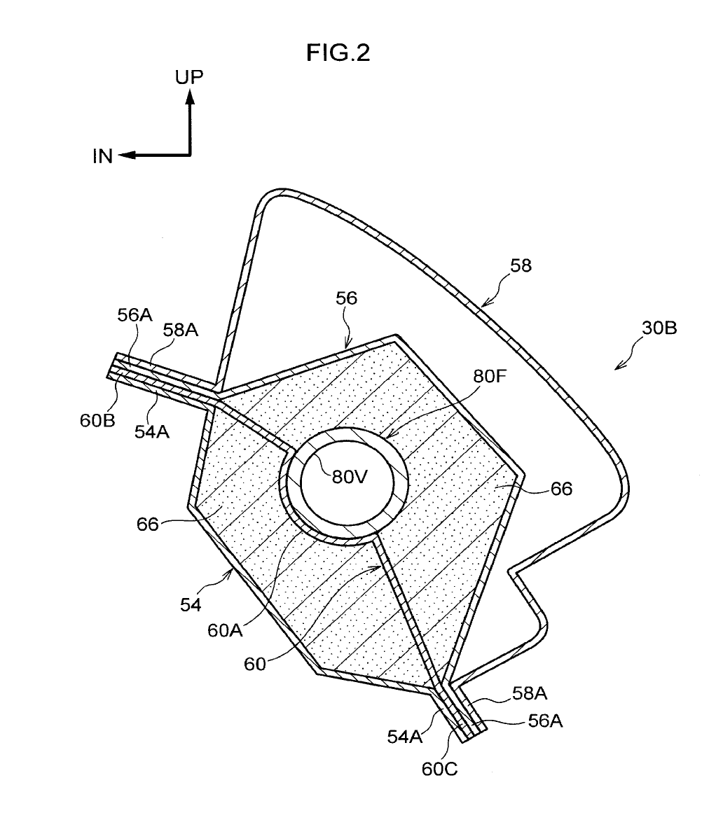

The front pillar upper 30B extends toward the vehicle upper side and the vehicle rear side from the upper end portion of the front pillar lower 30A. The front pillar upper 30B extends along a vehicle width direction outer side end portion of a windshield glass (a front glass), which is not shown in the drawings. A cross-sectional shape of the front pillar upper 30B viewed in the vehicle front-rear direction (a length direction thereof) is formed as a closed cross section shape (see FIG. 2). The roof side rail 70 extends toward the vehicle rear side from an upper end portion 30B1 of the front pillar upper 30B.

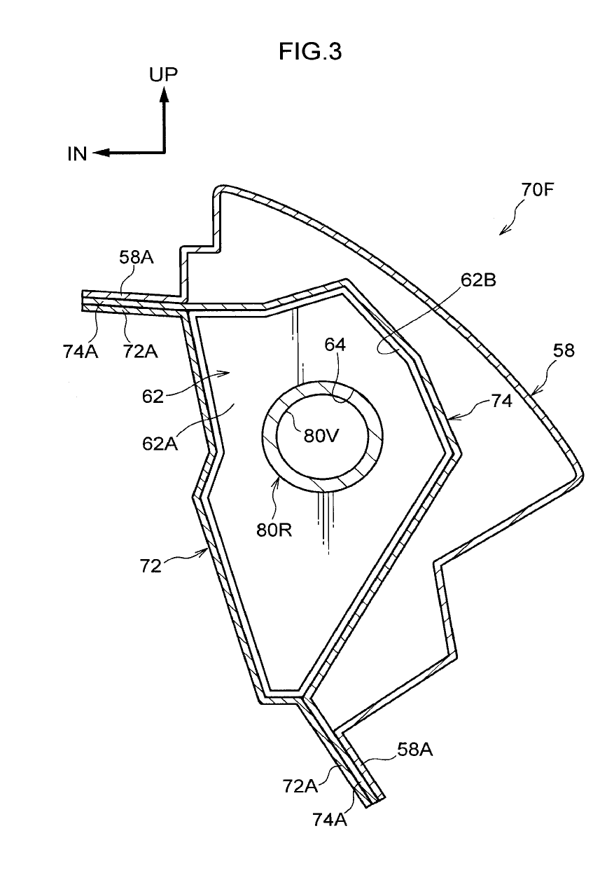

The roof side rail 70 is a framework member in a beam shape that is fabricated of metal. The roof side rail 70 forms upper edge portions at the vehicle upper sides of the front door opening portion 14 and the rear door opening portion 15. The roof side rail 70 is disposed along the vehicle front-rear direction at each of two vehicle width direction sides of a roof panel, which is not shown in the drawings. A cross-sectional shape of the roof side rail 70 viewed in the vehicle front-rear direction is formed as a closed cross section shape (see FIG. 3).

The roof side rail 70 includes a front portion 70F at the vehicle front side relative to the center pillar 90 and a rear portion 70R at the vehicle rear side relative to the center pillar 90. A front end portion 70F1 at the vehicle front side of the roof side rail 70 is joined to the upper end portion 30B1 of the front pillar upper 30B. A reference symbol “J” indicates a joint portion between the front end portion 70F1 of the roof side rail 70 and the upper end portion 30B1 of the front pillar upper 30B.

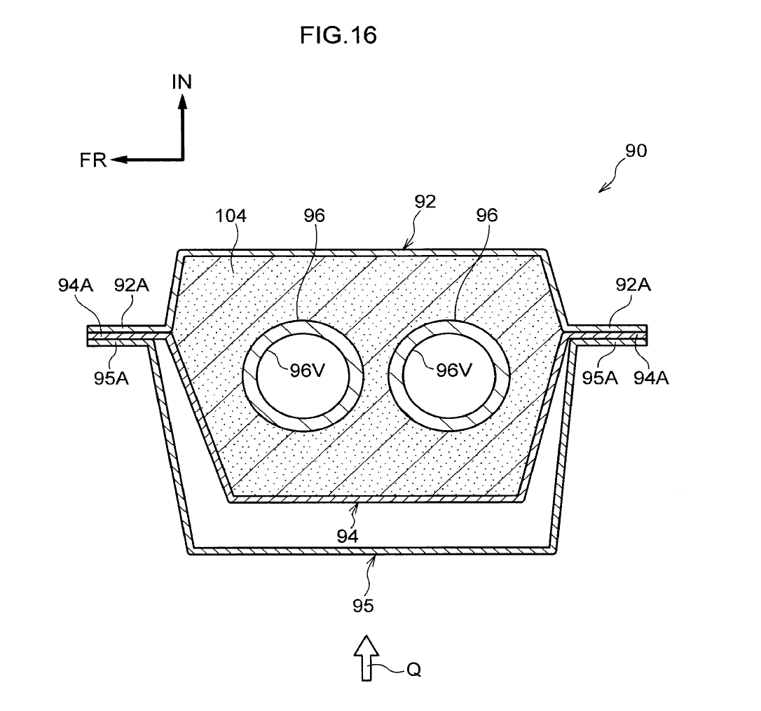

The center pillar 90 is a framework member formed as a column shape that is fabricated of metal. The center pillar 90 forms a rear edge portion at the vehicle rear side of the front door opening portion 14 and a front edge portion at the vehicle front side of the rear door opening portion 15. The center pillar 90 is disposed at the vehicle rear side relative to the front pillar 30. The center pillar 90 rises up in the vehicle vertical direction from a vehicle front-rear direction middle portion of the rocker 20. An upper end portion of the center pillar 90 is joined to a vehicle front-rear direction middle portion of the roof side rail 70. A cross-sectional shape of the center pillar 90 viewed in the vehicle vertical direction (a length direction thereof) is formed as a closed cross section shape (see FIG. 16). A rear pillar, which is not shown in the drawings, is disposed at the vehicle rear side relative to the center pillar 90. The rear pillar forms a rear edge portion at the vehicle rear side of the rear door opening portion 15.

In the present exemplary embodiment, the front pillar upper 30B and the front portion 70F of the roof side rail 70 are reinforced by a reinforcing rod 80 and a foam material 66 (see FIG. 2). The reinforcing rod 80 is a rod-shaped reinforcing member that transmits a front impact load (a collision load) F that is inputted to the front pillar 30 in association with a front impact to the roof side rail 70. Specifically, the reinforcing rod 80 is a pipe member fabricated of metal that is disposed inside the front pillar upper 30B and the front portion 70F of the roof side rail 70. The reinforcing rod 80 is formed as a tubular shape and includes, extending over the whole length in a length direction thereof, a hollow portion 80V (see FIG. 2 and FIG. 3).

The reinforcing rod 80 is disposed along the length directions of the front pillar upper 30B and the front portion 70F of the roof side rail 70. A front end portion 80F at the vehicle front side (one length direction end side) of the reinforcing rod 80 is disposed inside the front pillar upper 30B, and is joined to the front pillar upper 30B via a front side bracket 60. A rear end portion 80R at the vehicle rear side (another length direction end side) of the reinforcing rod 80 is disposed inside the front portion 70F of the roof side rail 70, and is joined to the front portion 70F via a rear side bracket 62. A length direction middle portion 80M of the reinforcing rod 80 is joined to the front portion 70F of the roof side rail 70 via a middle bracket 68.

Below, cross-sectional structures of the front pillar upper 30B and the front portion 70F of the roof side rail 70 are described, in addition to which structures of the front side bracket 60 and the rear side bracket 62 are described. The middle bracket 68 has a similar structure to the front side bracket 60. Accordingly, the middle bracket 68 is not described. The front side bracket 60, rear side bracket 62 and middle bracket 68 are an example of plural brackets that are disposed to be spaced apart in the length direction of the reinforcing rod 80 and support the reinforcing rod 80.

As shown in FIG. 2, the front pillar upper 30B includes a pillar upper inner panel 54, a pillar upper outer panel 56 and a side outer panel 58. The pillar upper inner panel 54 is a panel member that forms a portion at the vehicle width direction inner side of the front pillar upper 30B. A cross-sectional shape of the pillar upper inner panel 54 viewed in the vehicle front-rear direction is formed as a hat shape, the vehicle width direction outer side of which is open.

The pillar upper outer panel 56 is disposed at the vehicle width direction outer side of the pillar upper inner panel 54, and the side outer panel 58 is disposed at the vehicle width direction outer side of the pillar upper outer panel 56. The pillar upper outer panel 56 and the side outer panel 58 are panel members that form portions at the vehicle width direction outer side of the front pillar 30. Cross-sectional shapes of the pillar upper outer panel 56 and the side outer panel 58 viewed in the vehicle front-rear direction are formed as hat shapes, the vehicle width direction inner sides of which are open.

The pillar upper inner panel 54, pillar upper outer panel 56 and side outer panel 58 are joined together by welding or the like in a state in which respective upper and lower flange portions 54A, 56A and 58A thereof are superposed. As a result, a closed cross section is formed by the pillar upper inner panel 54 and the pillar upper outer panel 56, and a closed cross section is formed by the pillar upper outer panel 56 and the side outer panel 58.

The front side bracket 60 is disposed along the vehicle front-rear direction and the vehicle vertical direction, between the pillar upper inner panel 54 and the pillar upper outer panel 56. A cross-sectional shape of the front side bracket 60 viewed in the vehicle front-rear direction is formed as a hat shape, the vehicle width direction outer side of which is open. The front side bracket 60 includes an accommodation recess portion 60A, an upper side flange portion 60B and a lower side flange portion 60C.

The accommodation recess portion 60A is recessed to the vehicle width direction inner side relative to the upper side flange portion 60B and the lower side flange portion 60C. The accommodation recess portion 60A is a recess portion that extends in the vehicle front-rear direction along the front pillar upper 30B. A cross-sectional shape of the accommodation recess portion 60A viewed in the vehicle front-rear direction is formed as a circular arc shape that runs along an outer periphery face of the reinforcing rod 80. In a state in which the front end portion 80F of the reinforcing rod 80 is fitted into the inside of the accommodation recess portion 60A, the accommodation recess portion 60A and the front end portion 80F are joined together by welding or the like.

The upper side flange portion 60B extends toward the vehicle upper side and the vehicle width direction inner side from an upper end portion of the accommodation recess portion 60A. In a state in which the upper side flange portion 60B is sandwiched between the upper side flange portion 54A of the pillar upper inner panel 54 and the upper side flange portion 56A of the pillar upper outer panel 56, the upper side flange portion 60B is joined to the upper side flange portions 54A and 56A by welding or the like.

The lower side flange portion 60C extends to the vehicle lower side and the vehicle width direction outer side from a lower end portion of the accommodation recess portion 60A. In a state in which the lower side flange portion 60C is sandwiched between the lower side flange portion 54A of the pillar upper inner panel 54 and the lower side flange portion 56A of the pillar upper outer panel 56, the lower side flange portion 60C is joined to the lower side flange portions 54A and 56A by welding or the like.

As shown in FIG. 3, the front portion 70F of the roof side rail 70 includes a roof side rail inner panel 72, a roof side rail outer panel 74 and the side outer panel 58. The roof side rail inner panel 72 is a panel member that forms a portion at the vehicle width direction inner side of the roof side rail 70.

The roof side rail outer panel 74 is disposed at the vehicle width direction outer side of the roof side rail inner panel 72, and the side outer panel 58 is disposed at the vehicle width direction outer side of the roof side rail outer panel 74. The roof side rail outer panel 74 and the side outer panel 58 are panel members that form portions at the vehicle width direction outer side of the roof side rail 70. Cross-sectional shapes of the roof side rail outer panel 74 and of the side outer panel 58 viewed in the length directions thereof (the vehicle front-rear direction) are formed as hat shapes, the vehicle width direction inner sides of which are open. Note that the side outer panel 58 is the same member as the side outer panel 58 of the front pillar upper 30B described above (see FIG. 2).

The roof side rail inner panel 72, roof side rail outer panel 74 and side outer panel 58 are joined together by welding or the like in a state in which respective upper and lower flange portions 72A, 74A and 58A thereof are superposed. As a result, a closed cross section is formed by the roof side rail inner panel 72 and the roof side rail outer panel 74, and a closed cross section is formed by the roof side rail outer panel 74 and the side outer panel 58.

The rear side bracket 62 is disposed along the vehicle vertical direction and the vehicle width direction, between the roof side rail inner panel 72 and the roof side rail outer panel 74. The rear side bracket 62 serves as a bulkhead that is fitted into the inside of the roof side rail 70.

To be specific, the rear side bracket 62 includes a partition wall portion 62A and a flange portion 62B. The partition wall portion 62A is formed as a plate shape that extends in the vehicle vertical direction and the vehicle width direction. The partition wall portion 62A is disposed with a thickness direction thereof in the length direction of the roof side rail 70 (the vehicle front-rear direction). The partition wall portion 62A is fitted into the inside of the closed cross section that is formed by the roof side rail inner panel 72 and the roof side rail outer panel 74. The partition wall portion 62A partitions the inside of the closed cross section into plural sections (compartments) in the vehicle front-rear direction.

A mounting hole 64 is formed at a central portion of the partition wall portion 62A. The mounting hole 64 penetrates the partition wall portion 62A in the thickness direction thereof (the vehicle front-rear direction). The mounting hole 64 is formed as a circular hole whose diameter is slightly larger than a diameter of the rear end portion 80R of the reinforcing rod 80. The rear end portion 80R of the reinforcing rod 80 penetrates (is fitted into) the mounting hole 64 in the vehicle front-rear direction. An outer periphery portion of the rear end portion 80R is joined to the partition wall portion 62A by welding or the like.

The flange portion 62B extends toward the vehicle front side from an outer periphery portion of the partition wall portion 62A. The flange portion 62B is joined to inner wall faces of the roof side rail inner panel 72 and the roof side rail outer panel 74 by welding or the like.

As shown in FIG. 2, the foam material 66 is filled into the inside of the front pillar upper 30B. Similarly, the foam material 66 is filled into the inside of the front portion 70F of the roof side rail 70. The foam material 66 is, for example, a urethane-based hard foam. The foam material 66 is provided to extend over the whole length in the length direction of the reinforcing rod 80. That is, the reinforcing rod 80 is embedded, over the whole length thereof, inside the foam material 66. The front side bracket 60, the rear side bracket 62 and the middle bracket 68 are also embedded in the foam material 66.

More specifically, in the front pillar upper 30B, the foam material 66 is, for example, filled without gaps into the closed cross section surrounded by the pillar upper inner panel 54 and the pillar upper outer panel 56. The foam material 66 may also be filled into the closed cross section that is formed by the pillar upper outer panel 56 and the side outer panel 58.

Similarly, in the roof side rail 70, the foam material 66 is, for example, filled without gaps into the closed cross section that is formed by the roof side rail inner panel 72 and the roof side rail outer panel 74. The foam material 66 is not shown in FIG. 3. The foam material 66 may also be filled into the closed cross section that is formed by the roof side rail outer panel 74 and the side outer panel 58. The foam material 66 may further be filled into the inside of the reinforcing rod 80 (the hollow portion 80V).

Now, operation of the first exemplary embodiment is described.

If, for example, a collision object W has a micro-wrap collision with a vehicle front face of the vehicle 12 at the vehicle width direction outer side relative to a front side member, which is not shown in the drawings, operation is as follows. The collision object W may pass along at the vehicle width direction outer side of the front side member and, as indicated in FIG. 1, collide with the front pillar lower 30A directly or via the front wheel 16. A front impact load F toward the vehicle rear side that is inputted to the front pillar lower 30A in association with the micro-wrap collision is transmitted through the front pillar lower 30A and via the front pillar upper 30B to the roof side rail 70. At this time, stress may concentrate at the joint portion J between the front pillar upper 30B and the front end portion 70F1 of the roof side rail 70, and a deformation in which the joint portion J bends into a protrusion toward the vehicle upper side may occur.

However, in the present exemplary embodiment, the reinforcing rod 80 is disposed inside the front pillar upper 30B and the front portion 70F of the roof side rail 70, along the respective length directions thereof. The front end portion 80F of the reinforcing rod 80 is disposed inside the front pillar upper 30B and is joined to the front pillar upper 30B via the front side bracket 60. The rear end portion 80R of the reinforcing rod 80 is disposed inside the front portion 70F of the roof side rail 70 and is joined to the front portion 70F via the rear side bracket 62. Further, the middle portion 80M of the reinforcing rod 80 is joined to the front portion 70F of the roof side rail 70 via the middle bracket 68.

Therefore, the front impact load F that is inputted to the front pillar upper 30B through the front pillar lower 30A in association with the micro-wrap collision is transmitted to the roof side rail 70 via the reinforcing rod 80. Consequently, stress concentrating at the joint portion J between the front pillar upper 30B and the front end portion 70F1 of the roof side rail 70 is reduced. Therefore, a deformation in which the joint portion J between the front pillar upper 30B and the front end portion 70F1 of the roof side rail 70 bends into a protrusion toward the vehicle upper side in association with the micro-wrap collision is suppressed. Hence, deformation of the vehicle cabin 13 is suppressed.

As described above, the front end portion 80F of the reinforcing rod 80 is joined to the front pillar upper 30B via the front side bracket 60, and the rear end portion 80R is joined to the front portion 70F of the roof side rail 70 via the rear side bracket 62. Therefore, the reinforcing rod 80 may resist the front impact load F over substantially the whole length direction length thereof. Thus, the front pillar upper 30B and the front portion 70F of the roof side rail 70 may be reinforced efficiently.

The middle portion 80M of the reinforcing rod 80 is joined to the front portion 70F of the roof side rail 70 via the middle bracket 68. Thus, the rigidity (bending rigidity) of the reinforcing rod 80 is increased. Therefore, a deformation in which the joint portion J between the front pillar upper 30B and the front end portion 70F1 of the roof side rail 70 bends into a protrusion toward the vehicle upper side in association with a micro-wrap collision is suppressed.

The rear side bracket 62 includes the partition wall portion 62A that is disposed with the thickness direction thereof in the length direction of the roof side rail 70. The partition wall portion 62A is fitted into the inside of the closed cross section formed by the roof side rail inner panel 72 and the roof side rail outer panel 74. Therefore, crushing (buckling of the cross section) of the front portion 70F of the roof side rail 70 in association with a micro-wrap collision is suppressed.

Furthermore, in the present exemplary embodiment, the foam material 66 is filled into the insides of the front pillar upper 30B and the front portion 70F of the roof side rail 70. The reinforcing rod 80 is embedded inside the foam material 66 over the whole length direction length of the reinforcing rod 80. Therefore, the front impact load F is transmitted between the front pillar upper 30B and the reinforcing rod 80 via the foam material 66, and the front impact load F is transmitted between the reinforcing rod 80 and the front portion 70F of the roof side rail 70 via the foam material 66.

The cross-sectional shapes of the front pillar upper 30B and the front portion 70F of the roof side rail 70 are maintained by the foam material 66. Therefore, crushing (buckling of the cross section) of the front pillar upper 30B or the front portion 70F of the roof side rail 70 in association with a micro-wrap collision is suppressed.

In particular, in the present exemplary embodiment the foam material 66 is filled into both the upper end portion 30B1 of the front pillar upper 30B and the front end portion 70F1 of the roof side rail 70. Therefore, the cross-sectional shape of the joint portion J between the upper end portion 30B1 of the front pillar upper 30B and the front end portion 70F 1 of the roof side rail 70 is maintained by the foam material 66. Therefore, the deformation described above in which the joint portion J bends toward the vehicle upper side is further suppressed.

The reinforcing rod 80 includes the hollow portion 80V extending over the whole length in the length direction thereof. Therefore, for example, if the front impact load F inputted to the reinforcing rod 80 is at least a predetermined value, the hollow portion 80V of the reinforcing rod 80 is crushed and absorbs collision energy. Thus, deformation of the vehicle cabin 13 in association with a micro-wrap collision is suppressed.

Now, a variant example of the first exemplary embodiment is described.

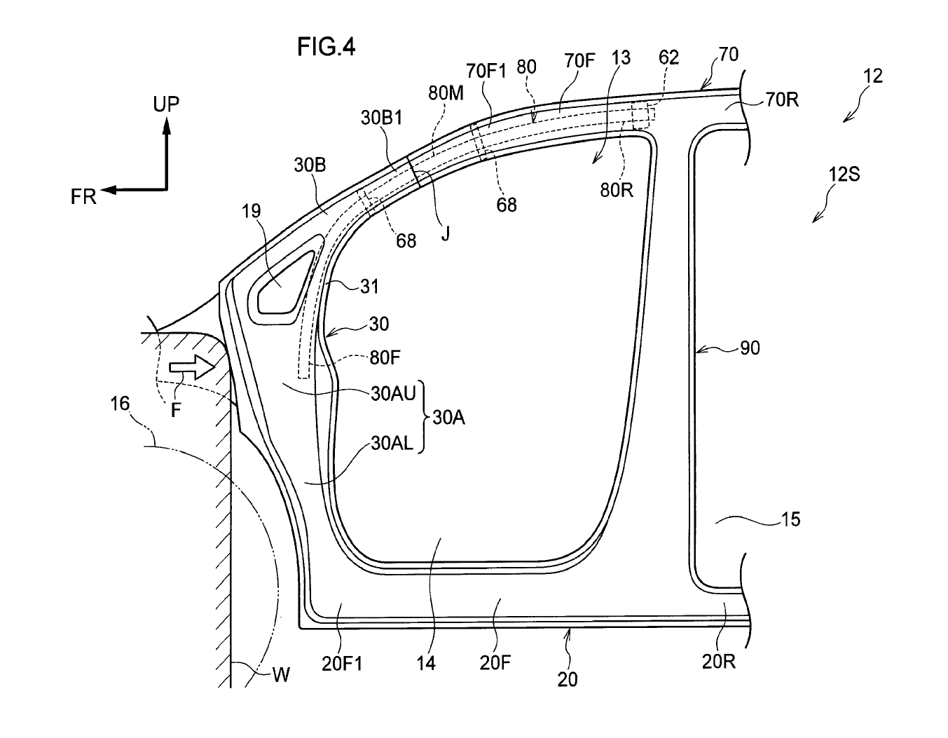

In a variant example illustrated in FIG. 4, the reinforcing rod 80 is provided to extend along the front pillar lower 30A and the front portion 70F of the roof side rail 70. That is, the reinforcing rod 80 is disposed along the front pillar lower 30A, the front pillar upper 30B and the front portion 70F of the roof side rail 70.

The rear end portion 80R of the reinforcing rod 80 is disposed inside the front portion 70F of the roof side rail 70, and is joined to the front portion 70F via the rear side bracket 62. The middle portion 80M of the reinforcing rod 80 is joined to the front portion 70F of the roof side rail 70 and the front pillar upper 30B via two of the middle bracket 68.

The front end portion 80F of the reinforcing rod 80 reaches from the front pillar upper 30B to the inside of the upper portion 30AU of the front pillar lower 30A, passing to the vehicle lower side of a framework portion 31 (an A′ pillar) at the vehicle rear side of the non-opening window 19. The front end portion 80F of the reinforcing rod 80 is disposed at the vehicle rear side relative to the apron upper member 18. In the present variant example, the front end portion 80F of the reinforcing rod 80 is not supported by a bracket. However, the front end portion 80F may be supported by a bracket.

If the vehicle 12 has a micro-wrap collision with a collision object W such as an SUV, a minivan or a box van in which the location of a front bumper is higher than in an ordinary vehicle (for example, a sedan), the collision object W may collide with the upper portion 30AU of the front pillar lower 30A (see arrow F in FIG. 4).

However, in the present variant example, even if the collision object W collides with the upper portion 30AU of the front pillar lower 30A, the collision object W may be borne by the front end portion 80F of the reinforcing rod 80. Therefore, deformation of the front pillar 30 toward the vehicle rear side in association with a micro-wrap collision may be more assuredly suppressed.

Now, a second exemplary embodiment is described. Members and the like that are the same as in the first exemplary embodiment are assigned the same reference symbols and are not described.

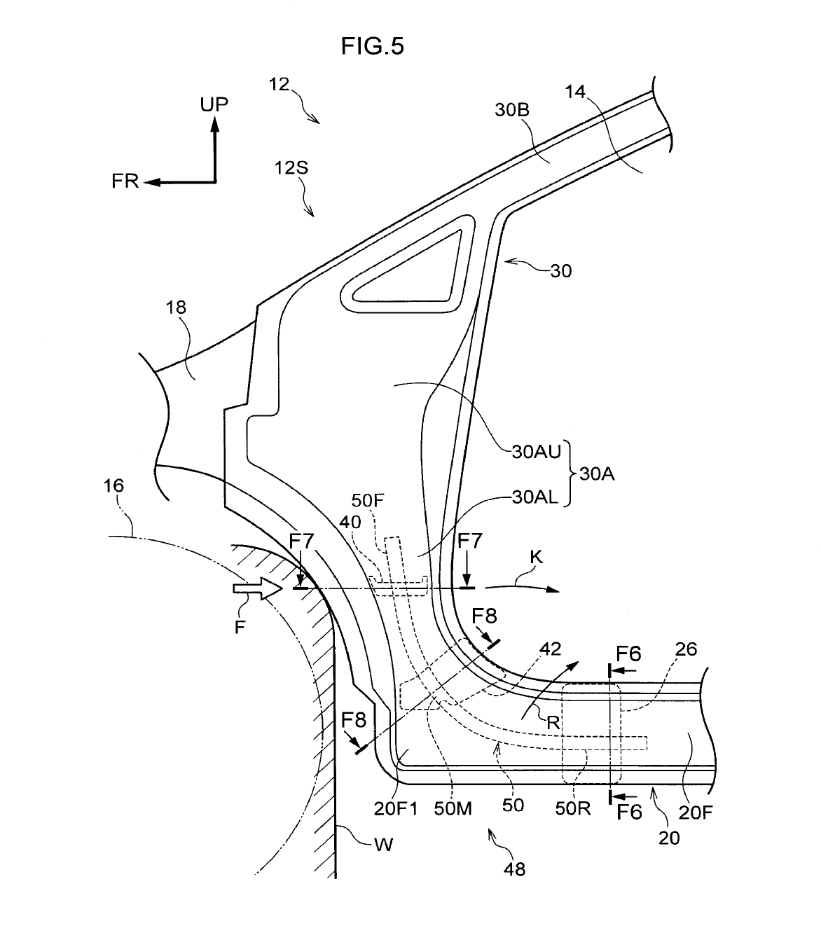

As shown in FIG. 5, a vehicle framework structure 48 according to the second exemplary embodiment is employed at the rocker 20 and the front pillar 30. The vehicle framework structure 48 is provided with a reinforcing rod 50 that is disposed to extend along the rocker 20 and the front pillar 30.

The reinforcing rod 50 is disposed inside the rocker 20 and the front pillar lower 30A (inside the closed cross sections thereof). The reinforcing rod 50 is a rod-shaped reinforcing member that transmits a front impact load (a collision load) F that is inputted to the front pillar 30 in association with a front impact to the rocker 20. Specifically, the reinforcing rod 50 is a pipe member fabricated of metal that is formed as a tubular shape. The reinforcing rod 50 includes a hollow portion 50V that extends over the whole length in a length direction thereof (see FIG. 6).

The reinforcing rod 50 is inflected in an “L” shape along the rocker 20 and the front pillar 30 as viewed in the vehicle width direction. A rear end portion 50R at the vehicle rear side (one length direction end side) of the reinforcing rod 50 is disposed inside a front portion of the rocker 20. The rear end portion 50R extends linearly along the rocker 20 in the vehicle front-rear direction and is joined to the rocker 20 via a rear side bracket 26.

As shown in FIG. 6, the rocker 20 is divided in the vehicle width direction, including a rocker outer panel 22 and a rocker inner panel 24. The rocker outer panel 22 is a panel member that forms a portion at the vehicle width direction outer side of the rocker 20. A cross-sectional shape of the rocker outer panel 22 viewed in the vehicle front-rear direction is formed as a hat shape, the vehicle width direction inner side of which is open. The rocker outer panel 22 includes an inner side wall portion 22A, an upper wall portion 22B, a lower wall portion 22C, and upper and lower flange portions 22D.

The rocker inner panel 24 is a panel member that forms a portion at the vehicle width direction inner side of the rocker 20. The rocker inner panel 24 is disposed at the vehicle width direction inner side of the rocker outer panel 22. A cross-sectional shape of the rocker inner panel 24 viewed in the vehicle front-rear direction is formed as a hat shape, the vehicle width direction outer side of which is open. The rocker inner panel 24 includes an inner side wall portion 24A, an upper wall portion 24B, a lower wall portion 24C, and upper and lower flange portions 24D.

The rocker outer panel 22 and rocker inner panel 24 are joined together by welding or the like in a state in which the respective upper and lower flange portions 22D and 24D thereof are superposed. A closed cross section is formed by the rocker outer panel 22 and the rocker inner panel 24. The reinforcing rod 50 is disposed in the closed cross section formed by the rocker outer panel 22 and the rocker inner panel 24.

The rear side bracket 26 is a panel member fabricated of metal that is disposed along the vehicle front-rear direction and the vehicle vertical direction. A cross-sectional shape of the rear side bracket 26 viewed in the vehicle front-rear direction is formed as a hat shape, the vehicle width direction inner side of which is open. The rear side bracket 26 includes an accommodation recess portion 28, an upper side flange portion 29A and a lower side flange portion 29B.

The accommodation recess portion 28 is recessed to the vehicle width direction outer side relative to the upper side flange portion 29A and the lower side flange portion 29B. The accommodation recess portion 28 is a recess portion that extends in the vehicle front-rear direction along the rocker 20. The rear end portion 50R of the reinforcing rod 50 is fitted into the inside of the accommodation recess portion 28.

The accommodation recess portion 28 includes a bottom wall portion 28A and a pair of holding wall portions 28B. The bottom wall portion 28A is disposed at the vehicle width direction outer side of the rear end portion 50R of the reinforcing rod 50 and is joined to the rear end portion 50R by welding or the like. The pair of holding wall portions 28B is disposed at both sides in the vehicle vertical direction of the rear end portion 50R of the reinforcing rod 50 and are joined to the rear end portion 50R by welding or the like. Because the rear end portion 50R of the reinforcing rod 50 is sandwiched from both sides in the vehicle vertical direction by the pair of holding wall portions 28B, displacement of the rear end portion 50R in the vehicle vertical direction is restrained.

The upper side flange portion 29A extends toward the vehicle upper side from a vehicle width direction inner side end portion of the holding wall portion 28B that is at the upper side. In a state in which the upper side flange portion 29A is sandwiched between the flange portions 22D and 24D at the upper sides of the rocker outer panel 22 and the rocker inner panel 24, the upper side flange portion 29A is joined to these flange portions 22D and 24D by welding or the like.

The lower side flange portion 29B extends toward the vehicle lower side from a vehicle width direction inner side end portion of the holding wall portion 28B that is at the lower side. In a state in which the lower side flange portion 29B is sandwiched between the flange portions 22D and 24D at the lower sides of the rocker outer panel 22 and the rocker inner panel 24, the lower side flange portion 29B is joined to these flange portions 22D and 24D by welding or the like.

As shown in FIG. 5, a front end portion 50F at the vehicle front side (another length direction end side) of the reinforcing rod 50 is disposed inside the lower portion 30AL of the front pillar lower 30A. The front end portion 50F extends linearly along the lower portion 30AL of the front pillar lower 30A in the vehicle vertical direction, and is joined to the lower portion 30AL via a front side bracket 40.

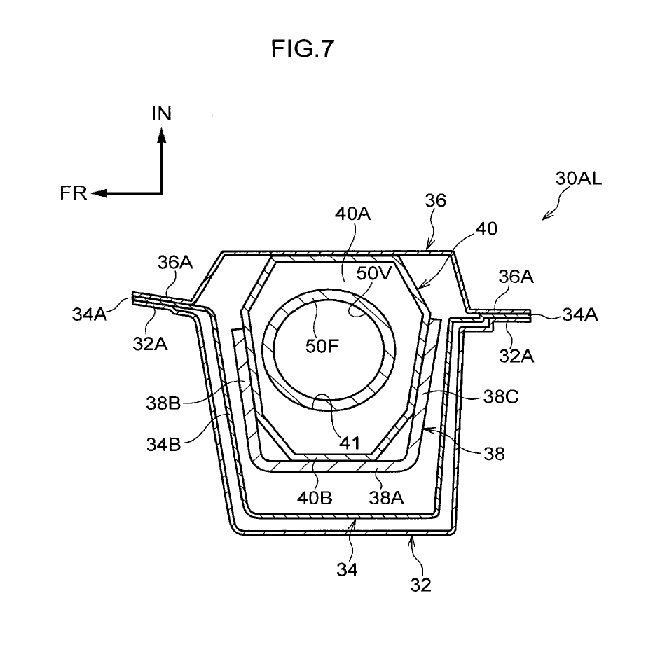

As shown in FIG. 7, the front pillar lower 30A includes a pillar outer panel 32, a pillar outer reinforcement 34, a pillar inner panel 36 and a hinge reinforcement 38.

The pillar outer panel 32 is disposed at the vehicle width direction outer side of the pillar outer reinforcement 34. The pillar outer panel 32 and the pillar outer reinforcement 34 are joined to one another, forming a panel member that forms a portion at the vehicle width direction outer side of the front pillar lower 30A. Cross-sectional shapes of the pillar outer panel 32 and of the pillar outer reinforcement 34 viewed in the vehicle vertical direction are formed as hat shapes, vehicle width direction inner sides of which are open. The pillar inner panel 36 is disposed at the vehicle width direction inner side of the pillar outer reinforcement 34.

The pillar inner panel 36 is a panel member that forms a portion at the vehicle width direction inner side of the front pillar lower 30A. A cross-sectional shape of the pillar inner panel 36 viewed in the vehicle vertical direction is formed as a hat shape, the vehicle width direction outer side of which is open. The pillar outer panel 32, pillar outer reinforcement 34 and pillar inner panel 36 are joined by welding or the like in a state in which respective front and rear flange portions 32A, 34A and 36A thereof are superposed. As a result, a closed cross section is formed by the pillar outer panel 32 and the pillar outer reinforcement 34, and a closed cross section is formed by the pillar outer reinforcement 34 and the pillar inner panel 36. The reinforcing rod 50 is disposed in the closed cross section that is formed by the pillar outer reinforcement 34 and the pillar inner panel 36.

The hinge reinforcement 38 is disposed between the pillar outer reinforcement 34 and the pillar inner panel 36. A cross-sectional shape of the hinge reinforcement 38 viewed in the vehicle vertical direction is formed as a “U” shape, the vehicle width direction inner side of which is open. The hinge reinforcement 38 includes an outer side wall portion 38A, a front wall portion 38B and a rear wall portion 38C. The outer side wall portion 38A is joined by welding or the like to both a door hinge, which is not shown in the drawings, and the pillar outer reinforcement 34. The front end portion 50F of the reinforcing rod 50 and the front side bracket 40 are disposed inside the hinge reinforcement 38.

The front side bracket 40 is disposed along the vehicle front-rear direction and the vehicle width direction, and serves as a bulkhead that is fitted into the inside of the hinge reinforcement 38. The front side bracket 40 includes a partition wall portion 40A and a flange portion 40B. The partition wall portion 40A is formed as a plate shape that extends in the vehicle front-rear direction and the vehicle width direction. The partition wall portion 40A is disposed with a thickness direction thereof in the length direction of the front pillar lower 30A (the vehicle vertical direction). The partition wall portion 40A partitions the inside of the front pillar lower 30A, more specifically the inside of the hinge reinforcement 38, into plural sections (compartments) in the vehicle vertical direction.

A mounting hole 41 is formed at a central portion of the partition wall portion 40A. The mounting hole 41 penetrates the partition wall portion 40A in the thickness direction thereof (the vehicle vertical direction). The mounting hole 41 is formed as a circular hole whose diameter is slightly larger than a diameter of the front end portion 50F of the reinforcing rod 50. The front end portion 50F of the reinforcing rod 50 penetrates (is fitted into) the mounting hole 41 in the vehicle vertical direction. An outer periphery portion of the front end portion 50F is joined to the partition wall portion 40A by welding or the like.

The flange portion 40B extends toward the vehicle upper side from an outer periphery portion of the partition wall portion 40A. The flange portion 40B is joined to the outer side wall portion 38A, the front wall portion 38B and the rear wall portion 38C of the hinge reinforcement 38 by welding or the like. Therefore, a front impact load F that is inputted to the front pillar lower 30A in association with a front impact (see FIG. 5) is transmitted to the front end portion 50F of the reinforcing rod 50 via the hinge reinforcement 38 and the front side bracket 40.

The front side bracket 40 may, for example, be fitted into the closed cross section that is formed by the pillar outer reinforcement 34 and the pillar inner panel 36.

A length direction middle portion 50M of the reinforcing rod 50 is formed as an inflected portion that is inflected to extend along the front end portion 20F1 of the rocker 20 and the lower portion 30AL of the front pillar lower 30A. The middle portion 50M is joined to a lower end portion of the front pillar lower 30A via a middle bracket 42. The rear side bracket 26, front side bracket 40 and middle bracket 42 described above are an example of plural brackets that are disposed to be spaced apart in the length direction of the reinforcing rod 50 and support the reinforcing rod 50.

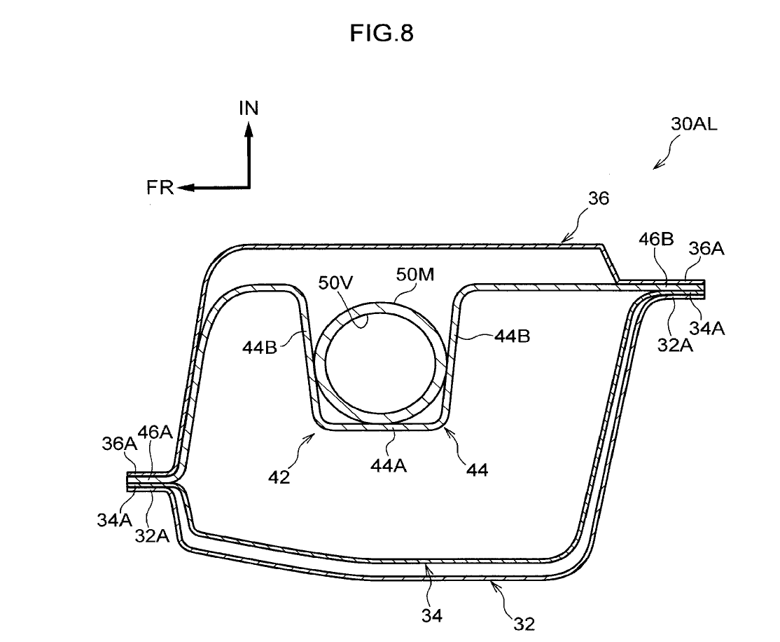

As shown in FIG. 8, the middle bracket 42 is disposed along the vehicle front-rear direction and the vehicle vertical direction inside the lower end portion of the front pillar lower 30A. A cross-sectional shape of the middle bracket 42 viewed in an axial direction of the middle portion 50M of the reinforcing rod 50 is formed as a hat shape, the vehicle width direction inner side of which is open. The middle bracket 42 includes an accommodation recess portion 44, a front side flange portion 46A and a rear side flange portion 46B.

The accommodation recess portion 44 is recessed to the vehicle width direction outer side relative to the front side flange portion 46A and the rear side flange portion 46B. The accommodation recess portion 44 is a recess portion, into the inside of which the middle portion 50M of the reinforcing rod 50 fits. The accommodation recess portion 44 includes a bottom wall portion 44A and a pair of holding wall portions 44B.

The bottom wall portion 44A is disposed at the vehicle width direction outer side of the middle portion 50M of the reinforcing rod 50 and is joined to the middle portion 50M by welding or the like. The pair of holding wall portions 44B are disposed at both sides in the vehicle front-rear direction of the middle portion 50M of the reinforcing rod 50 and are joined to the middle portion 50M by welding or the like. Because the middle portion 50M of the reinforcing rod 50 is sandwiched from both sides in the vehicle front-rear direction by the pair of holding wall portions 44B, displacement of the middle portion 50M in the vehicle front-rear direction is restrained.

The front side flange portion 46A extends toward the vehicle front side from a vehicle width direction inner side end portion of the holding wall portion 44B that is at the front side. In a state in which the front side flange portion 46A is sandwiched between the flange portions 34A and 36A at the front sides of the pillar outer reinforcement 34 and the pillar inner panel 36, the front side flange portion 46A is joined to these flange portions 34A and 36A by welding or the like.

The rear side flange portion 46B extends toward the vehicle rear side from a vehicle width direction inner side end portion of the holding wall portion 44B that is at the rear side. In a state in which the rear side flange portion 46B is sandwiched between the flange portions 34A and 36A at the rear sides of the pillar outer reinforcement 34 and the pillar inner panel 36, the rear side flange portion 46B is joined to these flange portions 34A and 36A by welding or the like.

Now, operation of the present exemplary embodiment is described.

As shown in FIG. 5, according to the vehicle framework structure 48 according to the present exemplary embodiment, the reinforcing rod 50 is inflected in an “L” shape along the rocker 20 and the front pillar 30 as viewed from the vehicle width direction outer side. The rear end portion 50R of the reinforcing rod 50 is disposed inside the rocker 20 and is joined to the rocker 20 via the rear side bracket 26.

The front end portion 50F of the reinforcing rod 50 is disposed inside the lower portion 30AL of the front pillar lower 30A and is joined to the lower portion 30AL via the front side bracket 40. The middle portion 50M of the reinforcing rod 50 is disposed inside the lower end portion of the front pillar lower 30A and is joined to this lower end portion via the middle bracket 42.

If, in association with a micro-wrap collision, a collision object W collides with the front pillar lower 30A directly or via the front wheel 16, a front impact load F toward the vehicle rear is inputted to the front pillar 30. The front impact load F is inputted to the front end portion 50F of the reinforcing rod 50 via the front side bracket 40. As a result, the front end portion 50F of the reinforcing rod 50 bendingly deforms toward the vehicle rear side (in the direction of arrow K), pivoting about the middle bracket 42, and the front impact load F is transmitted to the rocker 20 via the rear end portion 50R. That is, the reinforcing rod 50 resists the front impact load F in accordance with a bending rigidity thereof. Therefore, deformation (tilting) of the front pillar 30 toward the vehicle rear side in association with the micro-wrap collision is suppressed.

Thus, in the present exemplary embodiment, a front impact load F associated with a micro-wrap collision may be transmitted to the rocker 20 by the front end portion 50F of the reinforcing rod 50 bearing the front impact load F. Therefore, deformation of the front pillar 30 toward the vehicle rear side in association with the micro-wrap collision may be suppressed efficiently. Hence, deformation of the vehicle cabin 13 is suppressed.

Further, because the reinforcing rod 50 inflects from the front end portion 20F1 of the rocker 20 and extends toward the vehicle upper side along the front pillar lower 30A, a front impact load F that is inputted to the front pillar lower 30A may be borne in a range extending along the reinforcing rod 50 from the middle portion 50M to the front end portion 50F. Therefore, deformation of the front pillar 30 toward the vehicle rear in association with a micro-wrap collision may be more assuredly suppressed.

The front end portion 50F of the reinforcing rod 50 is joined to the front pillar lower 30A via the front side bracket 40. The front side bracket 40 includes the partition wall portion 40A that extends in the vehicle front-rear direction and the vehicle width direction. Therefore, a front impact load F that is inputted to the front pillar 30 is efficiently transmitted to the front end portion 50F via the partition wall portion 40A.

The cross-sectional shape of the front pillar lower 30A is maintained by the partition wall portion 40A. Therefore, crushing (buckling of the cross section) of the front pillar lower 30A is suppressed. As a result, a front impact load F is more efficiently transmitted to the rocker 20 via the front pillar lower 30A and the reinforcing rod 50.

The middle portion 50M of the reinforcing rod 50 is joined to the lower end portion of the front pillar lower 30A via the middle bracket 42. Thus, because the middle bracket 42 supports the middle portion 50M of the reinforcing rod 50, bending rigidity of the reinforcing rod 50 against a front impact load F is increased.

The rear end portion 50R of the reinforcing rod 50 is joined to the rocker 20 via the rear side bracket 26. The rear side bracket 26 is disposed along the vehicle front-rear direction and the vehicle vertical direction.

If the front end portion 50F of the reinforcing rod 50 bendingly deforms toward the vehicle rear side, the rear end portion 50R of the reinforcing rod 50 acts so as to lift up toward the vehicle rear side, pivoting about the rear side bracket 26 (in the direction of arrow R in FIG. 5). However, in the present exemplary embodiment, the rear side bracket 26 is disposed along the vehicle front-rear direction and the vehicle vertical direction as mentioned above. Therefore, the rear side bracket 26 efficiently resists the above-described turning of the rear end portion 50R of the reinforcing rod 50.

As shown in FIG. 6, the rear side bracket 26 includes the pair of holding wall portions 28B. Because the rear end portion 50R of the reinforcing rod 50 is sandwiched from both sides in the vehicle vertical direction by the pair of holding wall portions 28B, turning of the rear end portion 50R is further suppressed. Therefore, deformation of the front pillar 30 toward the vehicle rear side in association with a micro-wrap collision is further suppressed.

The reinforcing rod 50 includes the hollow portion 50V extending over the whole length in the length direction thereof. Therefore, for example, if a front impact load F inputted to the front end portion 50F of the reinforcing rod 50 is at least a predetermined value, the hollow portion 50V of the reinforcing rod 50 is crushed and absorbs collision energy. Thus, deformation of the vehicle cabin 13 in association with a micro-wrap collision is suppressed.

Now, variant examples of the second exemplary embodiment are described.

In the second exemplary embodiment described above, the middle bracket 42 is provided inside the lower end portion of the front pillar lower 30A, but the second exemplary embodiment is not limited thus. For example, the middle bracket 42 may be provided inside the front end portion 20F1 of the rocker 20, or the middle bracket 42 may be provided to extend along the insides of the lower end portion of the front pillar lower 30A and the front end portion 20F1 of the rocker 20.

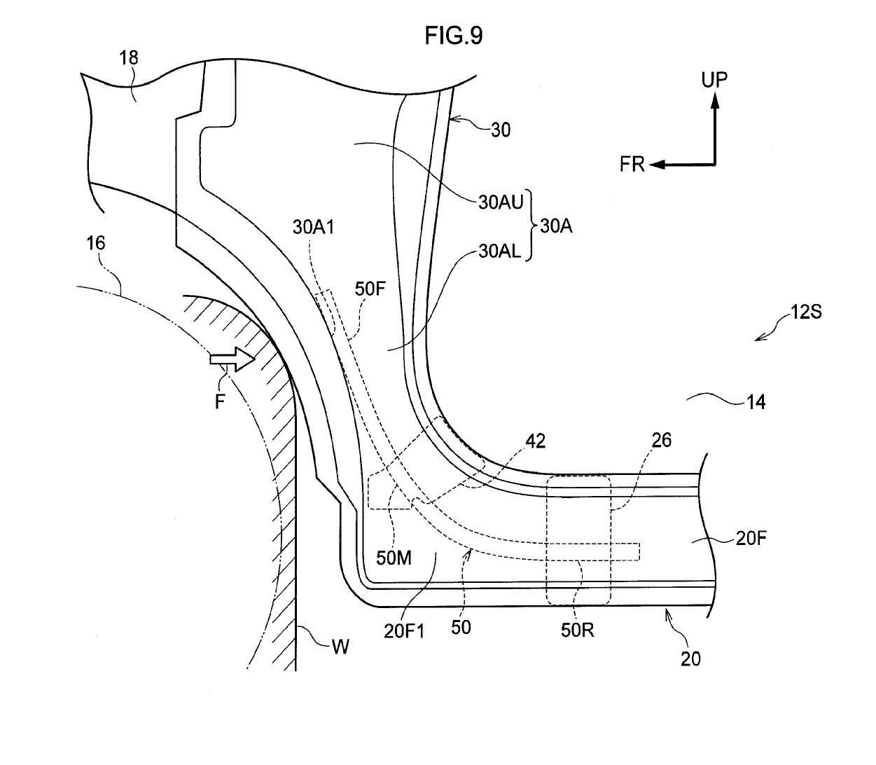

To continue, in a variant example illustrated in FIG. 9, the front side bracket 40 that supports the front end portion 50F is omitted, but an outer periphery face of the front end portion 50F is in contact with a front wall portion 30A1 at the vehicle front side of the front pillar lower 30A. A front impact load F that that is inputted to the front pillar lower 30A is borne by this front end portion 50F. Therefore, crushing of the front wall portion 30A1 of the front pillar lower 30A is suppressed. The front wall portion 30A1 of the front pillar lower 30A is formed by, for example, a front wall portion 34B at the vehicle front side of the pillar outer reinforcement 34 (see FIG. 7).

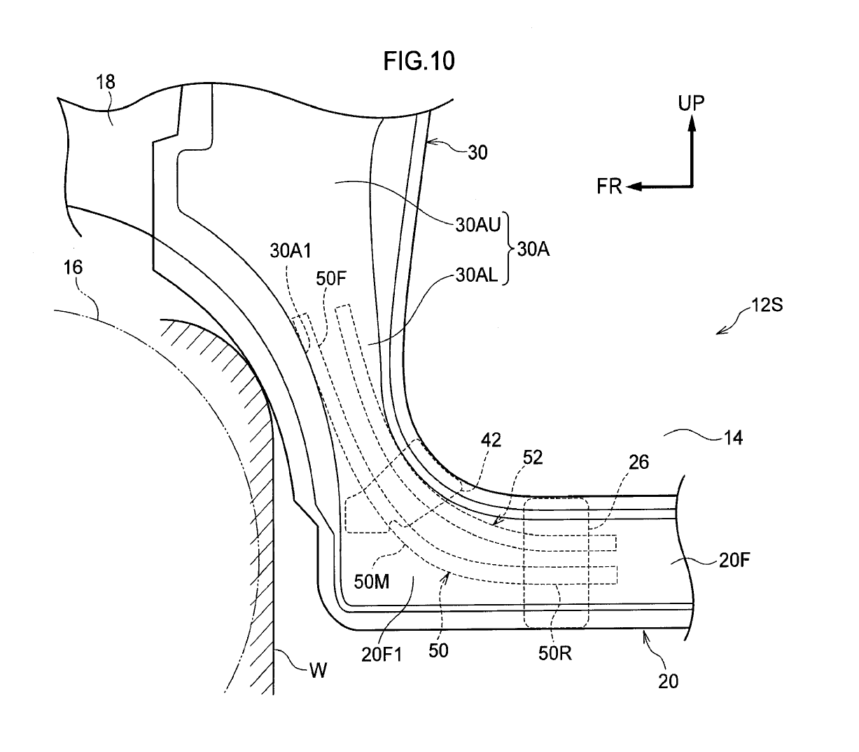

In the above second exemplary embodiment, the single reinforcing rod 50 is provided inside the rocker 20 and the front pillar lower 30A, but the second exemplary embodiment is not limited thus. For example, in a variant example illustrated in FIG. 10, two reinforcing rods 50 and 52 are provided inside the rocker 20 and the front pillar lower 30A. As a result, rigidity of the front pillar lower 30A in the vehicle front-rear direction is increased. Therefore, deformation of the front pillar 30 toward the vehicle rear side in association with a front impact is further suppressed.

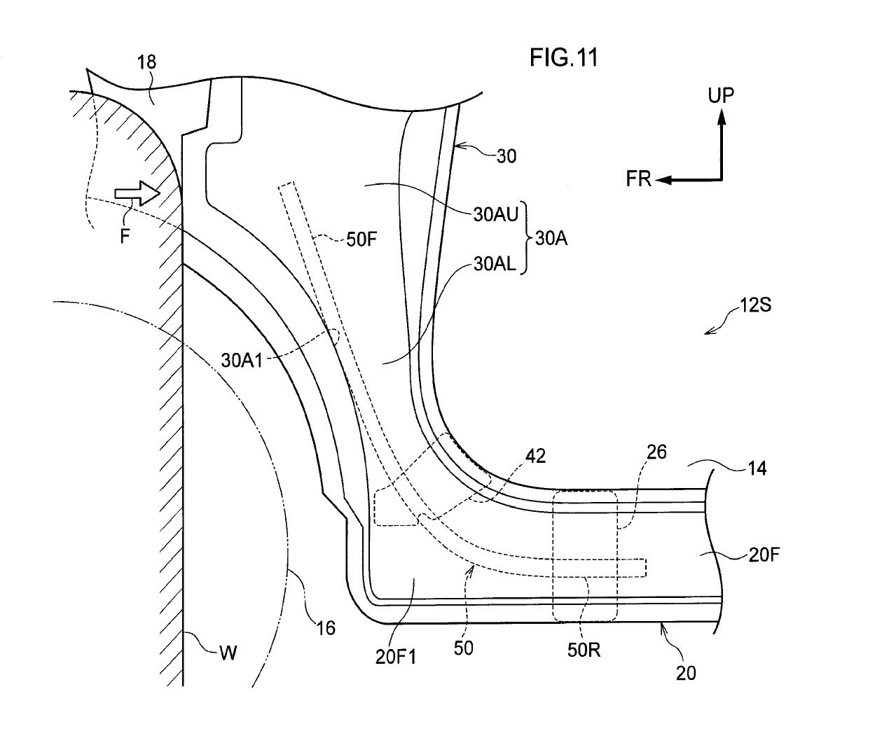

In the above second exemplary embodiment, the front end portion 50F of the reinforcing rod 50 is disposed inside the lower portion 30AL of the front pillar lower 30A, but the second exemplary embodiment is not limited thus. For example, as in the variant example illustrated in FIG. 11, the front end portion 50F of the reinforcing rod 50 may be disposed inside the upper portion 30AU of the front pillar lower 30A.

Specifically, the front end portion 50F extends from the front end portion 20F1 of the rocker 20 through the lower portion 30AL of the front pillar lower 30A to the upper portion 30AU of the front pillar lower 30A. This front end portion 50F is disposed to the vehicle rear side of the apron upper member 18, and an outer periphery portion of the front end portion 50F is in contact with the front wall portion 30A1 of the front pillar lower 30A. In the present variant example, the front side bracket 40 that supports the front end portion 50F (see FIG. 5) is omitted.

As described for the variant example of the first exemplary embodiment (see FIG. 4), if, for example, the vehicle 12 has a micro-wrap collision with a collision object W such as an SUV or the like in which the location of a front bumper is higher than in an ordinary vehicle (for example, a sedan), the collision object W may collide with the upper portion 30AU of the front pillar lower 30A.

However, in the present variant example, even if a collision object W collides with the upper portion 30AU of the front pillar lower 30A, the collision object W may be borne by the front end portion 50F of the reinforcing rod 50. Therefore, deformation of the front pillar 30 toward the vehicle rear side in association with a micro-wrap collision may be more assuredly suppressed.

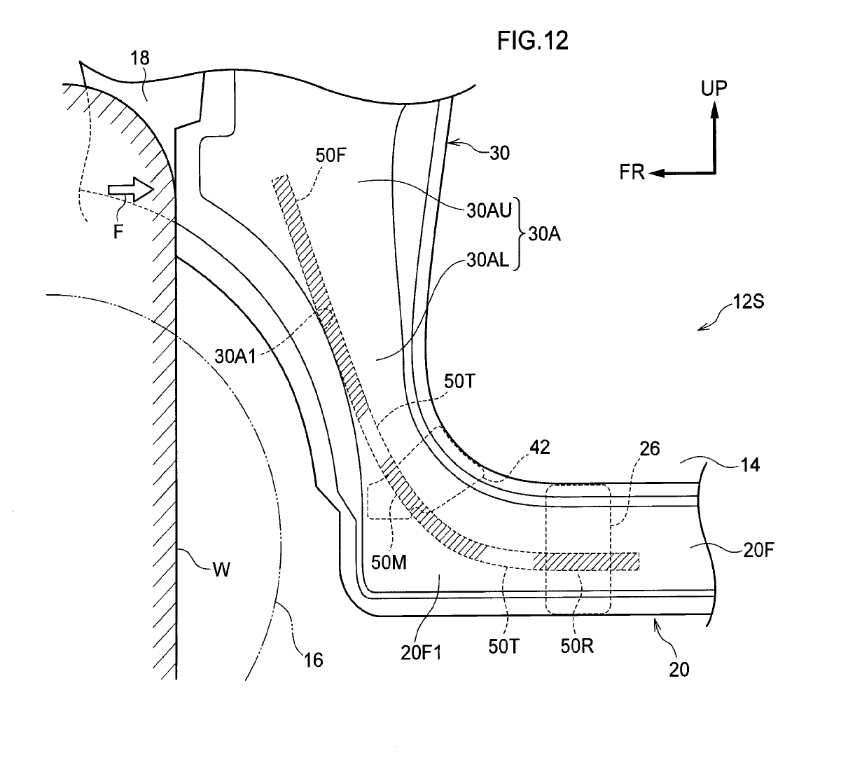

In a variant example illustrated in FIG. 12, two weakened portions 50T are provided in the reinforcing rod 50. Specifically, the two weakened portions 50T are provided at portions of the reinforcing rod 50 at both of the vehicle front-rear direction sides of the middle bracket 42.

In the present variant example, the two weakened portions 50T are formed as follows. Portions of the reinforcing rod 50 other than the two weakened portions 50T (the shaded portions in FIG. 12) are increased in strength (for example, bending strength) relative to the two weakened portions 50T by heat treatment such as quenching or the like. Accordingly, portions of the reinforcing rod 50 with relatively low strength (the portions that are not the shaded portions) serve as the two weakened portions 50T. The heat treatment that is employed may be, for example, the three-dimensional hot bending and quenching mentioned below.

If, for example, a front impact load F inputted to the front end portion 50F of the reinforcing rod 50 in association with a front impact is at least a predetermined value, the reinforcing rod 50 bendingly deflects, starting from one or both of the two weakened portions 50T. Collision energy is absorbed in accordance with this bending deflection of the reinforcing rod 50. Therefore, deformation of the front pillar 30 toward the vehicle rear side in association with a front impact is further suppressed.

In the present variant example, two of the weakened portions 50T are formed by the application of heat treatment to predetermined portions of the reinforcing rod 50, but the present variant example is not limited thus. Weakened portions may be portions of the reinforcing rod 50 at which penetrating holes, incisions or the like are formed. Moreover, the number and arrangement of weakened portions provided in the reinforcing rod 50 may be suitably modified.

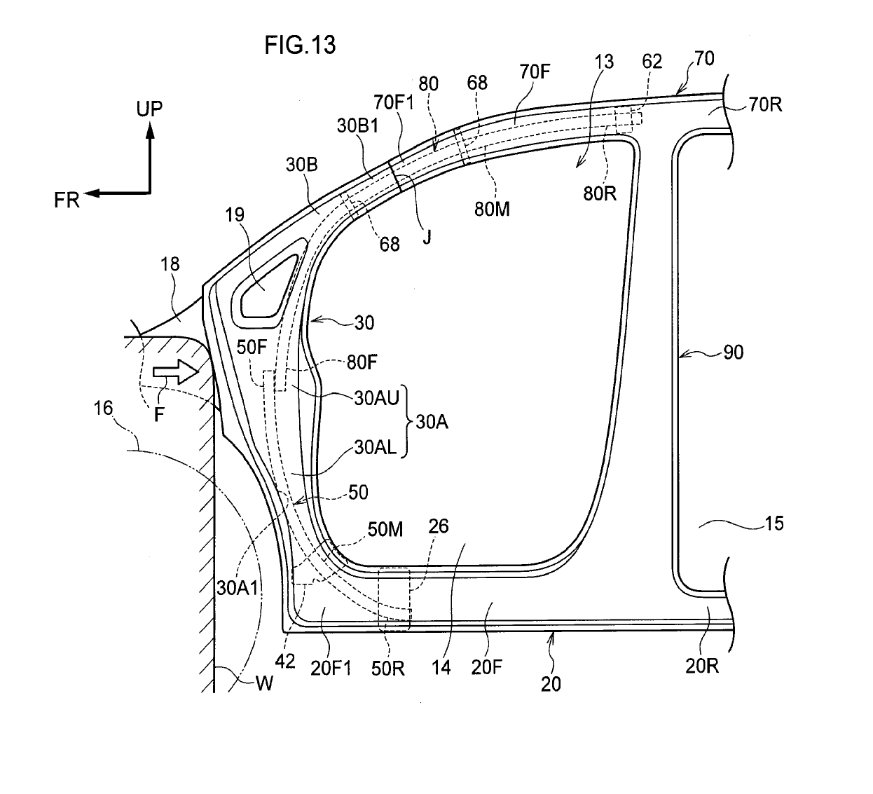

In a variant example illustrated in FIG. 13, the front end portion 80F of the reinforcing rod 80 according to the first exemplary embodiment (a first reinforcing rod) and the front end portion 50F of the reinforcing rod 50 according to the second exemplary embodiment (a second reinforcing rod) are disposed inside the upper portion 30AU of the front pillar lower 30A. The front end portions 50F and 80F of these reinforcing rods 50 and 80 are disposed side-by-side in the vehicle front-rear direction at the vehicle rear side relative to the apron upper member 18.

Thus, a front impact load F that is inputted to the upper portion 30AU of the front pillar lower 30A in association with a micro-wrap collision with an SUV or the like may be borne by the front end portions 50F and 80F of the reinforcing rods 50 and 80. The front impact load F that is inputted to the front end portion 80F of the reinforcing rod 80 is transmitted through the reinforcing rod 80 to the front pillar upper 30B and the roof side rail 70, and the front impact load F that is inputted to the front end portion 50F of the reinforcing rod 50 is transmitted through the reinforcing rod 50 to the rocker 20. That is, the front impact load F is dispersed and transmitted to the roof side rail 70 at the vehicle upper portion and the rocker 20 at the vehicle lower portion. Therefore, deformation of the vehicle cabin 13 is further suppressed.

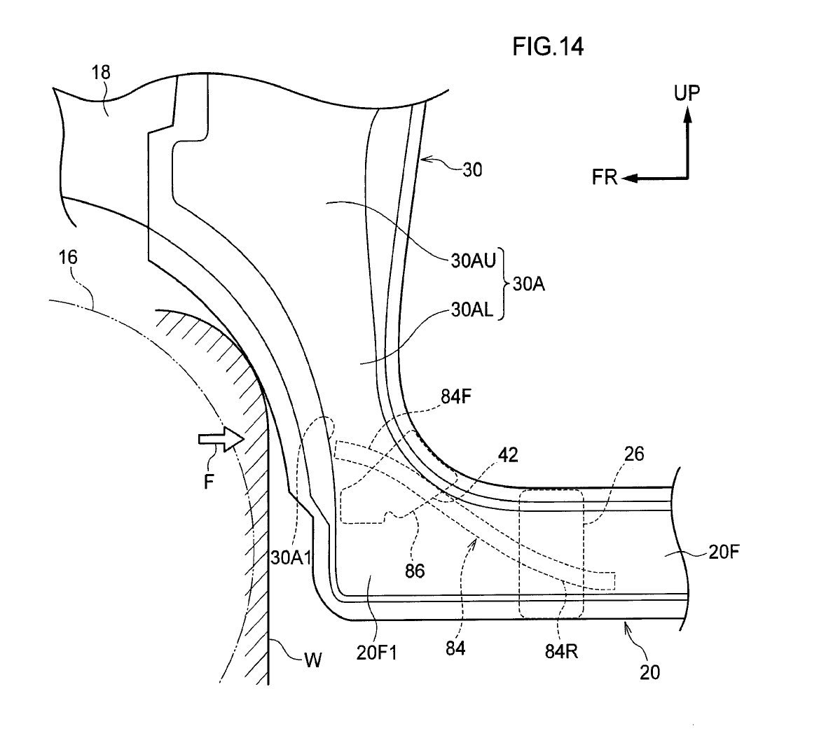

In a variant example illustrated in FIG. 14, a reinforcing rod 84 is provided to extend along the lower end portion of the front pillar lower 30A and the front portion 20F of the rocker 20. The reinforcing rod 84 is angled relative to the vehicle front-rear direction such that a front end portion 84F thereof is disposed at the vehicle upper side relative to a rear end portion 84R thereof.

The reinforcing rod 84 is loosely inflected in an “S” shape such that the front end portion 84F is oriented toward the vehicle front side. The front end portion 84F of the reinforcing rod 84 is disposed inside the lower end portion of the front pillar lower 30A, and the front end portion 84F contacts or is close to the front wall portion 30A1 at the vehicle front side of the front pillar lower 30A. The front end portion 84F of the reinforcing rod 84 is joined to the lower end portion of the front pillar lower 30A via a front side bracket 86. The front side bracket 86 has a similar structure to the middle bracket 42 described above (see FIG. 8).

Meanwhile, the rear end portion 84R of the reinforcing rod 84 is disposed inside the front portion 20F of the rocker 20. The rear end portion 84R of the reinforcing rod 84 is disposed close to the lower wall portions 22C and 24C of the rocker 20 (see FIG. 6). The rear end portion 84R of the reinforcing rod 84 is joined to the rocker 20 via the rear side bracket 26.

In this case, if, for example, the vehicle 12 tilts forward in association with a front impact, the reinforcing rod 84 is tilted forward and turned such that the rear end portion 84R lifts up relative to the front end portion 84F. Therefore, an inclination angle of the reinforcing rod 84 relative to the vehicle front-rear direction is reduced. As a result, a front impact load F that is inputted to the lower end portion of the front pillar lower 30A is inputted to the front end portion 84F of the reinforcing rod 84 in an axial direction (length direction) of the reinforcing rod 84. Thus, the reinforcing rod 84 resists the front impact load F with axial strength (axial rigidity). Therefore, the front impact load F that is inputted to the lower end portion of the front pillar lower 30A is more efficiently transmitted through the reinforcing rod 84 to the front portion 20F of the rocker 20.

Now, a third exemplary embodiment is described. Members and the like that are the same as in the first and second exemplary embodiments are assigned the same reference symbols and are not described.

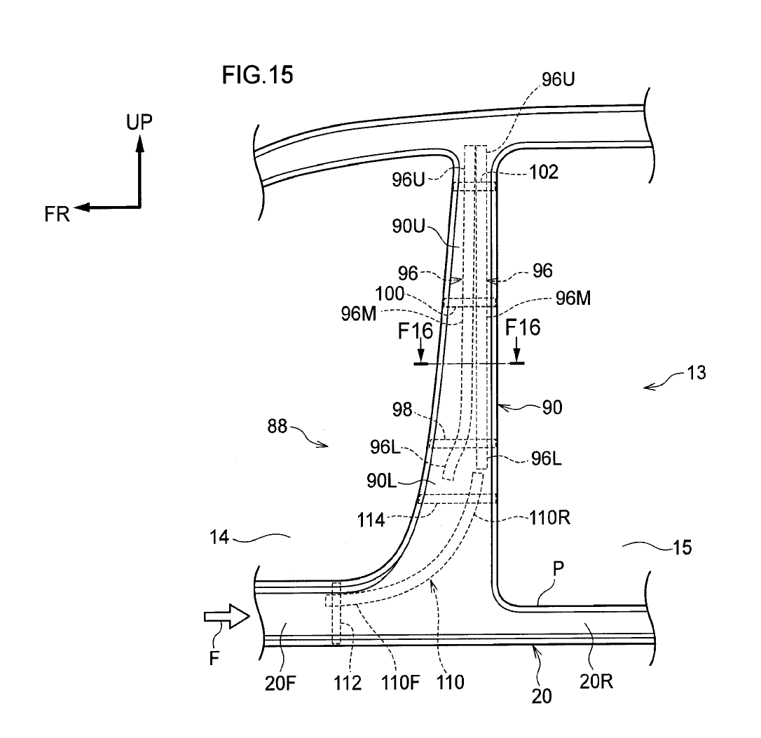

As shown in FIG. 15, a vehicle framework structure 88 according to the third exemplary embodiment is employed at the center pillar 90 and the rocker 20. The vehicle framework structure 88 is provided with reinforcing rods 96 (first reinforcing rods) that are disposed inside the center pillar 90 and a reinforcing rod 110 (a second reinforcing rod) that is disposed to extend along the center pillar 90 and the front portion 20F of the rocker 20.

Specifically, two of the reinforcing rods 96 are disposed inside the center pillar 90. The reinforcing rods 96 are disposed to extend from a lower portion 90L to an upper portion 90U of the center pillar 90. The reinforcing rods 96 extend in the vehicle vertical direction along the center pillar 90 and are disposed side-by-side in the vehicle front-rear direction. Each reinforcing rod 96 is formed as a tubular shape and includes, extending over the whole length in a length direction thereof, a hollow portion 96V (see FIG. 16).

A vehicle vertical direction lower end portion 96L, a middle portion 96M and an upper end portion 96U of each reinforcing rod 96 are joined to the center pillar 90 via, respectively, a lower side bracket 98, a middle bracket 100 and an upper side bracket 102.

The lower side bracket 98, middle bracket 100 and upper side bracket 102 have similar structures to, for example, the front side bracket 60 (see FIG. 2) or the rear side bracket 62 (see FIG. 3) provided in the roof side rail 70. The lower side bracket 98, the middle bracket 100 and the upper side bracket 102 are an example of plural brackets that are disposed to be spaced apart in the length direction of the reinforcing rods 96 and support the reinforcing rods 96.

As shown in FIG. 16, the center pillar 90 includes a center pillar inner panel 92, a center pillar outer panel (a center pillar outer reinforcement) 94 and a side outer panel 95.

The center pillar inner panel 92 is a panel member that forms a portion at the vehicle width direction inner side of the center pillar 90. A cross-sectional shape of the center pillar inner panel 92 viewed in the vehicle vertical direction is formed as a hat shape, the vehicle width direction outer side of which is open.

The center pillar outer panel 94 is disposed at the vehicle width direction outer side of the center pillar inner panel 92, and the side outer panel 95 is disposed at the vehicle width direction outer side of the center pillar outer panel 94. The center pillar outer panel 94 and the side outer panel 95 are panel members that form portions at the vehicle width direction outer side of the center pillar 90. Cross-sectional shapes of the center pillar outer panel 94 and of the side outer panel 95 viewed in the vehicle vertical direction are formed as hat shapes, the vehicle width direction inner sides of which are open.

The center pillar inner panel 92, center pillar outer panel 94 and side outer panel 95 are joined together by welding or the like in a state in which respective front and rear flange portions 92A, 94A and 95A thereof are superposed. As a result, a closed cross section is formed by the center pillar inner panel 92 and the center pillar outer panel 94, and a closed cross section is formed by the center pillar outer panel 94 and the side outer panel 95.

In the present exemplary embodiment, the two reinforcing rods 96 are disposed in the closed cross section that is formed by the center pillar inner panel 92 and the center pillar outer panel 94, and a foam material 104 is filled without gaps into the closed cross section formed by the center pillar inner panel 92 and the center pillar outer panel 94.

The foam material 104 is, for example, a urethane-based hard foam. The foam material 104 is provided to extend over the whole length in the length direction of the two reinforcing rods 96. That is, the two reinforcing rods 96 are embedded, over the whole lengths thereof, inside the foam material 104. The rigidity of the center pillar 90 in the vehicle width direction (bending rigidity) is increased by the reinforcing rods 96 and the foam material 104. The foam material 104 may also be filled into the closed cross section that is formed by the center pillar outer panel 94 and the side outer panel 95.

Further, as shown in FIG. 15, in the third exemplary embodiment the reinforcing rod 110 is disposed to extend along the front portion 20F of the rocker 20 and the lower portion 90L of the center pillar 90. The reinforcing rod 110 is formed as a tubular shape and includes, extending over the whole length in a length direction thereof, a hollow portion (which is not shown in the drawings). The reinforcing rod 110 is inflected in an “L” shape as viewed in the vehicle width direction, along the front portion 20F of the rocker 20 and the lower portion 90L of the center pillar 90. A front end portion 110F at the vehicle front side (one length direction end side) of the reinforcing rod 110 is disposed inside the front portion 20F of the rocker 20, and is joined to the front portion 20F via a front side bracket 112.

Meanwhile, a rear end portion 110R at the vehicle rear side (another length direction end side) of the reinforcing rod 110 is disposed inside the lower portion 90L of the center pillar 90, and is joined to the lower portion 90L via a rear side bracket 114. Therefore, a front impact load F that is inputted to the rocker 20 in association with a front impact is transmitted through the reinforcing rod 110 to the lower portion 90L of the center pillar 90.

The front side bracket 112 and the rear side bracket 114 have similar structures to, for example, the front side bracket 60 (see FIG. 2) or the rear side bracket 62 (see FIG. 3) provided in the roof side rail 70. The front side bracket 112 and the rear side bracket 114 are an example of plural brackets that are disposed to be spaced apart in the length direction of the reinforcing rod 110 and support the reinforcing rod 110.

Now, operation of the third exemplary embodiment is described.

As shown in FIG. 16, if, for example, a side impact load (a collision load) Q toward the vehicle width direction inner side is inputted to the center pillar 90 in association with a side collision (below referred to simply as a “side impact”) in which a collision object collides with a vehicle side face, the center pillar 90 may deform toward the vehicle width direction inner side.

However, in the present exemplary embodiment, the two reinforcing rods 96 are disposed inside the center pillar 90. Moreover, the lower end portions 96L, middle portions 96M and upper end portions 96U of the two reinforcing rods 96 are joined to the center pillar 90 by, respectively, the lower side bracket 98, the middle bracket 100 and the upper side bracket 102. The two reinforcing rods 96 resist the side impact load Q by bending rigidity. Therefore, deformation of the center pillar 90 toward the vehicle width direction inner side is suppressed. Thus, deformation of the vehicle cabin 13 in association with the side impact is suppressed.

The foam material 104 is filled into the inside of the center pillar 90. Specifically, the foam material 104 is filled into the closed cross section formed by the center pillar inner panel 92 and the center pillar outer panel 94. The two reinforcing rods 96 are embedded, over the whole length in the length directions thereof, inside the foam material 104. Therefore, a side impact load Q is efficiently transmitted between the center pillar inner panel 92 and center pillar outer panel 94 and the two reinforcing rods 96 via the foam material 104.

The cross-sectional shapes of the center pillar inner panel 92 and the center pillar outer panel 94 are maintained by the foam material 104. Therefore, crushing (buckling of the cross section) of the center pillar 90 in association with a side impact is suppressed. Thus, deformation of the center pillar 90 toward the vehicle width direction inner side is further suppressed.

The two reinforcing rods 96 include the hollow portions 96V extending over the whole length in the length directions thereof. Therefore, if a side impact load Q inputted to the reinforcing rod 96 is at least a predetermined value, the hollow portions 96V of the reinforcing rods 96 are crushed and absorb collision energy. Thus, deformation of the center pillar 90 in association with a side impact is further suppressed.

To continue, as shown in FIG. 15, if a front impact load F toward the vehicle rear side is inputted to the front portion 20F of the rocker 20 in association with a front impact, operation is as follows. The front impact load F that is inputted to the front portion 20F of the rocker 20 is transmitted to the rear portion 20R of the rocker 20 and to the center pillar 90.

In this case, if the vehicle 12 tilts forward in association with the front impact and a vehicle rear portion of the vehicle 12 lifts up relative to a vehicle front portion, then, for example, a predetermined portion of the rear portion 20R of the rocker 20 (a portion P at the side of the rear portion 20R at which the center pillar 90 is disposed) may deform to bend into a protrusion toward the vehicle lower side. In particular, in a vehicle in which the weight of the vehicle rear portion is heavy, such as a station wagon or the like, the rear portion 20R of the rocker 20 is vulnerable to deforming to bend into a protrusion toward the vehicle lower side in association with a front impact.

However, in the present exemplary embodiment, the reinforcing rod 110 is disposed to extend along the front portion 20F of the rocker 20 and the lower portion 90L of the center pillar 90. The front end portion 110F of the reinforcing rod 110 is disposed inside the front portion 20F of the rocker 20 and is joined to the front portion 20F via the front side bracket 112. Meanwhile, the rear end portion 110R of the reinforcing rod 110 is disposed inside the lower portion 90L of the center pillar 90 and is joined to the lower portion 90L via the rear side bracket 114.

Therefore, the front impact load F that is inputted to the front portion 20F of the rocker 20 in association with the front impact is efficiently transmitted to the lower portion 90L of the center pillar 90 via the reinforcing rod 110. The front impact load F that is inputted to the lower portion 90L of the center pillar 90 is further transmitted to the roof side rail 70 via the upper portion 90U of the center pillar 90, and is dispersed and transmitted to the roof panel, which is not shown in the drawings, via the roof side rail 70.

Thus, a front impact load F that is transmitted from the front portion 20F of the rocker 20 to the rear portion 20R is made relatively small. As a result, a deformation in which the rear portion 20R of the rocker 20 (for example, the portion P) bends into a protrusion toward the vehicle lower side in association with a front impact is suppressed.

The foam material 104 is filled into the insides of the front portion 20F of the rocker 20 and the lower portion 90L of the center pillar 90, and the reinforcing rod 110 is embedded inside the foam material 104 over the whole length in the length direction of the reinforcing rod 110. Therefore, a front impact load F is transmitted between the front portion 20F of the rocker 20 and the reinforcing rod 110 via the foam material 104. The front impact load F is also transmitted between the reinforcing rod 110 and the lower portion 90L of the center pillar 90 via the foam material 104.

The cross-sectional shapes of the front portion 20F of the rocker 20 and the lower portion 90L of the center pillar 90 are maintained by the foam material 104. Therefore, crushing (buckling of the cross sections) of the front portion 20F of the rocker 20 and the lower portion 90L of the center pillar 90 in association with a front impact is suppressed. Thus, deformation of the center pillar 90 in association with a front impact is further suppressed.

The reinforcing rod 110 includes the hollow portion extending over the whole length in the length direction thereof. Therefore, for example, if a front impact load F inputted to the reinforcing rod 110 is at least a predetermined value, the hollow portion of the reinforcing rod 110 is crushed and absorbs collision energy. Thus, deformation of the vehicle cabin 13 is suppressed.

Now, variant examples of the third exemplary embodiment are described.

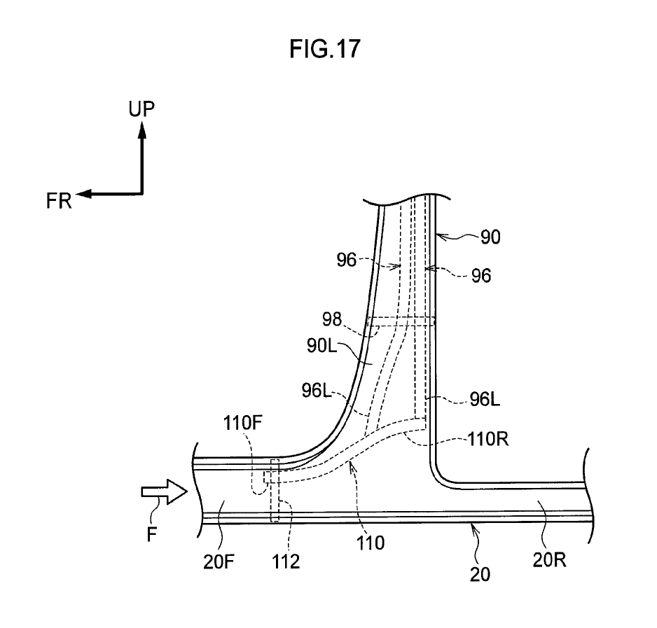

In a variant example illustrated in FIG. 17, the reinforcing rod 110 is loosely inflected in an “S” shape. The lower end portions 96L of the two reinforcing rods 96 are respectively joined to a rear end side of the reinforcing rod 110 by welding or the like. Therefore, a front impact load F that that is inputted to the front portion 20F of the rocker 20 is efficiently transmitted to the two reinforcing rods 96 via the reinforcing rod 110. Thus, a deformation in which the rear portion 20R of the rocker 20 bends into a protrusion toward the vehicle lower side in association with a front impact is suppressed.

However, one or other of the two reinforcing rods 96 may be joined to the rear end side of the reinforcing rod 110.

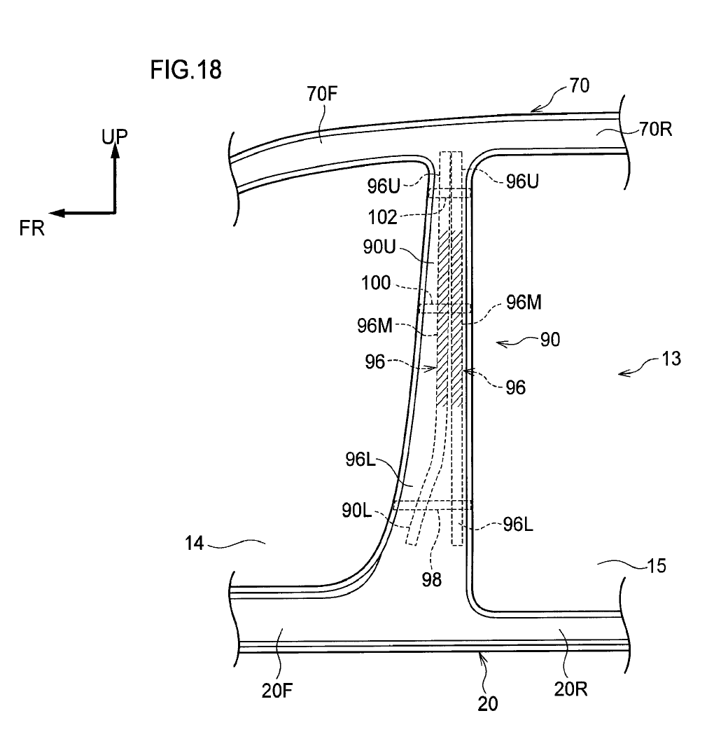

In a variant example illustrated in FIG. 18, a heat treatment has been applied to the length direction middle portions 96M of the two reinforcing rods 96. Thus, the middle portions 96M of the two reinforcing rods 96 are given higher strength than portions at the respective length direction ends thereof. As a result, deformation of the center pillar 90 in the vehicle width direction in association with a side impact is suppressed.

The heat treatment used on the reinforcing rods 96 is, for example, three-dimensional hot bending and quenching (3DQ). Three-dimensional hot bending and quenching is a machining process (a heat treatment process) that implements three-dimensional machining while a steel member is being quenched. More specifically, this is, for example, a machining process that continuously performs bending machining while a steel pipe (a pipe member) is being locally heated and quenched by water cooling. Compared to cold machining such as hydroforming or the like, three-dimensional hot bending and quenching is excellent in that steel pipes with high tensile strength (high-tensile steel pipes) in complex shapes may be fabricated efficiently.

In the present variant example, the heat treatment is applied to the middle portions 96M of the two reinforcing rods 96. However, the portions to which the heat treatment is applied may be suitably altered. Furthermore, a heat treatment such as three-dimensional hot bending and quenching or the like is not limited to the two reinforcing rods 96 but may be suitably applied to the various reinforcing rods in the first and second exemplary embodiments described above.

Now, variant examples of the first to third exemplary embodiments are described. Descriptions of the various variant examples are given below in relation to the example of the first exemplary embodiment described above, but these variant examples may be also be applied to the second and third exemplary embodiments as appropriate.

In the above first exemplary embodiment, the reinforcing rod 80 is supported by three brackets: the front side bracket 60, the rear side bracket 62 and the middle bracket 68. However, the reinforcing rod 80 may be supported by two brackets that are disposed to be spaced apart in the length direction of the reinforcing rod 80.

Moreover, shapes of the front side bracket 60, the rear side bracket 62 and the middle bracket 68 may be altered. Specifically, in the above first exemplary embodiment, the cross-sectional shape of the front side bracket 60 viewed in the vehicle front-rear direction is, as an example, a hat shape of which the vehicle width direction outer side is open. However, the cross-sectional shape of the front side bracket 60 viewed in the vehicle front-rear direction may be a hat shape of which the vehicle width direction inner side is open.

As a further example, the front side bracket 60 may be formed as a bulkhead, similarly to the rear side bracket 62. That is, the front end portion 80F and the rear end portion 80R of the reinforcing rod 80 may be supported by bulkheads that serve as brackets. In this case, the joint portion J between the front pillar upper 30B and the roof side rail 70 may be reinforced by the reinforcing rod 80, and crushing (buckling of the cross sections) of the front pillar upper 30B and the front portion 70F of the roof side rail 70 may be suppressed by the bulkheads.

The rear side bracket 62 may be formed by two components that are divided in the vehicle vertical direction or the vehicle width direction. In this case, it is easier to assemble the rear side bracket 62 to the front portion 70F of the roof side rail 70. In the above first exemplary embodiment, the rear side bracket 62 is formed as a bulkhead. However, the rear side bracket 62 may be formed as, for example, a bracket that is disposed along the vehicle front-rear direction and the vehicle vertical direction similarly to the front side bracket 60.

In the above first exemplary embodiment, the reinforcing rod 80 is embedded inside the foam material 66 over the whole length in the length direction of the reinforcing rod 80, but the first exemplary embodiment is not limited thus. At least a portion at the reinforcing rod 80 may be embedded inside the foam material 66. Further, the foam material 66 may be omitted.

Recess portions for noise reduction (noise reduction recess portions) may be formed as a surface of the foam material 66. Specifically, tiny recess portions between neighboring foam particles are formed as the surface of the foam material 66. As a result, a phase difference is produced between reflected waves of sound that are reflected by the surface of the foam material 66 and reflected waves of sound that are reflected by bottom faces of the recess portions. For sound of a particular frequency, the reflected waves of sound reflected by the surface of the foam material 66 and the reflected waves of sound reflected by the bottom faces of the recess portions are in antiphase. The two reflected waves that are in antiphase are superposed with one another and cancel each other out, thus reducing noise. Therefore, noise of a particular frequency or the like may be reduced by adjusting the sizes of the foam particles and forming recess portions of predetermined depths in the surface of the foam material 66.

In the above first exemplary embodiment, the reinforcing rod 80 includes the hollow portion 80V that extends over the whole length in the length direction thereof, but the first exemplary embodiment is not limited thus. For example, a metal material, a resin material or the like may be partially filled into the reinforcing rod 80, in which case the hollow portion 80V is formed partially in the reinforcing rod 80. Further, the reinforcing rod 80 is not limited to a pipe member but may be formed by a solid rod-shaped member.

The first exemplary embodiment described above is effective not just in respect to a micro-wrap collision but also in respect to various collision modes such as a full-wrap collision, an offset collision, a side impact and so forth.

Hereabove, the present invention has been described in accordance with the exemplary embodiments, but the present invention is not limited by these exemplary embodiments. The exemplary embodiments and various variant examples may be used in suitable combinations, and it will be clear that numerous modes may be embodied within a technical scope not departing from the gist of the present invention.

What is claimed is:

1. A vehicle framework structure, comprising:
a framework member that structures a framework of a vehicle, a cross-sectional shape of the framework member viewed in a length direction thereof being formed as a closed cross section shape;
a reinforcing rod disposed inside the framework member along the length direction of the framework member; and
a plurality of brackets provided inside the framework member so as to be spaced apart in a length direction of the reinforcing rod, the plurality of brackets supporting the reinforcing rod.

2. The vehicle framework structure according to claim 1, wherein the reinforcing rod comprises a tubular hollow portion.

3. The vehicle framework structure according to claim 1, further comprising a foam material filled into the inside of the framework member, wherein at least a portion of the reinforcing rod is embedded in the foam material.

4. The vehicle framework structure according to claim 1, wherein at least one of the plurality of brackets is a bulkhead that includes a partition wall portion that is disposed with a thickness direction thereof in the length direction of the framework member, and that is fitted into the inside of the framework member, and the reinforcing rod penetrates the partition wall portion.

5. The vehicle framework structure according to claim 1, wherein:
the framework member includes: a front pillar disposed at a side portion of a front end side of a vehicle cabin; and a roof side rail that extends toward a vehicle rear side from an upper end portion of the front pillar;
the reinforcing rod is provided to extend along the front pillar and the roof side rail; and
the brackets are provided in each of the front pillar and the roof side rail.

6. The vehicle framework structure according to claim 5, wherein:
the front pillar includes: a front pillar lower that is disposed along a vehicle vertical direction; and a front pillar upper that extends toward a vehicle upper side and the vehicle rear side from an upper end portion of the front pillar lower, an upper end portion of the front pillar upper being joined to a front end portion of the roof side rail;
a front end portion of the reinforcing rod is supported by a bracket of the plurality of brackets that is provided inside the front pillar upper; and
a rear end portion of the reinforcing rod is supported by a bracket of the plurality of brackets that is provided inside the roof side rail.

7. The vehicle framework structure according to claim 5, further comprising an apron upper member that extends toward a vehicle front side from the front pillar, wherein a front end portion of the reinforcing rod is disposed at the vehicle rear side relative to the apron upper member.
